(19) United States
(12) Patent Application Publication
(10) Pub. No.: US 2025/0055364 A1
(43) Pub. Date: Feb. 13, 2025

(54) CONTROL DEVICE AND CONTROL METHOD

(71) Applicant: NIDEC CORPORATION, Kyoto (JP)

(72) Inventors: Tetsuzo NAGAHISA, Kyoto (JP); Tomohiro FUKUMURA, Kyoto (JP)

(21) Appl. No.: 18/721,193

(22) PCT Filed: Dec. 20, 2022
(86) PCT No.: PCT/JP2022/046982

§ 371 Date: Jun. 18, 2024

(30) Foreign Application Priority Data
Dec. 24, 2021 (JP) 2021-211311

(51) Int. Cl. H02P 27/08

(52) U.S. Cl. CPC H02P 27/085

(57) ABSTRACT

A control device controls an N-phase inverter that applies voltage to each of N phases when N is an odd number of three or more. The control device includes a current detection unit and a calculation unit. When a phase to which (N+1)/2-th largest voltage is applied at a current detection time among voltages applied to the N phases is defined as an intermediate phase, the current detection unit detects current of each of the (N−1) phases other than the intermediate phase among currents of the N phases. The calculation unit calculates a current value of current in the intermediate phase based on a detection result of the current detection unit.

### TECHNICAL FIELD

The present disclosure relates to a control device and a control method.

### BACKGROUND ART

Conventionally, a microcomputer that controls a three-phase brushless motor is known (for example, Patent Literature 1).

In a conventional microcomputer, a PWM formation unit outputs a PWM signal of each phase obtained by modulating a carrier wave (triangular wave) of 16 kHz based on a voltage command value to an inverter circuit. A motor is driven by the inverter circuit. A shunt resistor is interposed between an emitter of an IGBT on the lower arm side of the inverter circuit and the ground, and the emitter of the IGBT is connected to an input terminal of an amplification bias circuit.

Further, in a conventional microcomputer, current signals for three phases are provided to each of two A/D converters, and input of a current signal of any one phase is switched in each of the converters to perform A/D conversion, so that A/D conversion values for two phases are obtained simultaneously. Since detection of current by a shunt resistor can be performed only during a period in which an IGBT on the lower arm side is turned on, the A/D conversion is performed at a timing when a bottom of a triangular wave of a PWM carrier wave is reached. If two phases among three-phase currents can be detected, the remaining one phase can be estimated.

### CITATIONS LIST

### Patent Literature

Patent Literature 1: JP 2003-164197 A

### SUMMARY OF INVENTION

### Technical Problems

However, in a conventional microcomputer, current of an intermediate phase corresponding to second largest phase voltage and current of a minimum phase corresponding to smallest phase voltage are detected at a current detection time among phase voltages of three phases in two-phase modulation wave energization.

In particular, the inventor of the present application has knowledge that fluctuation of current of an intermediate phase is larger than fluctuation of current of a minimum phase. In addition, the inventor of the present application has knowledge that current is likely to be disturbed in the vicinity of zero crossing of current. According to such knowledge, an error of a detection result of current of an intermediate phase may be larger than an error of a detection result of current of a minimum phase. In other words, in a conventional microcomputer, detection values of current flowing through each phase may vary. The present disclosure has been made in view of the above problem, and an object of the present disclosure is to provide a control device and a control method capable of reducing variation in a detection value of current flowing through each phase.

### Solutions to Problems

An exemplary control device of the present disclosure controls an N-phase inverter that applies voltage to each of N phases when N is an odd number of three or more. The control device includes a current detection unit and a calculation unit. When a phase to which (N+1)/2-th largest voltage is applied at a current detection time among voltages applied to the N phases is defined as an intermediate phase, the current detection unit detects current of each of the (N−1) phases other than the intermediate phase among currents of the N phases. The calculation unit calculates a current value of current in the intermediate phase based on a detection result of the current detection unit.

An exemplary control method of the present disclosure is executed by a control device that controls an N-phase inverter that applies voltage to each of N phases when N is an odd number of three or more. The control method includes a current detection step and a calculation step. In the current detection step, when a phase to which (N+1)/2-th largest voltage is applied at a current detection time among voltages applied to each of the N phases is defined as an intermediate phase, current of each of the (N−1) phases other than current of the intermediate phase among currents of the N phases is detected. In the calculation step, a current value of current in the intermediate phase is calculated based on a detection result of the current detection step.

### Advantageous Effects of Invention

According to the exemplary present disclosure, it is possible to reduce variation in a detection value of current flowing through each phase.

### BRIEF DESCRIPTION OF DRAWINGS

FIG. 1 is a block diagram illustrating a motor module according to a first embodiment of the present disclosure.

FIG. 2 is a diagram illustrating a waveform (three-phase modulation) of voltage applied to each phase and a waveform of current of each phase in the first embodiment.

FIG. 3 is a circuit diagram illustrating a three-phase inverter according to the first embodiment.

FIG. 4 is a diagram illustrating an example of voltage (three-phase modulation) applied to each phase, a carrier wave, and a compare value in the first embodiment.

FIG. 5 is a diagram illustrating transitions of an intermediate phase, a maximum phase, and a minimum phase in an electrical angle range of 0 [degE] to 360 [degE] in the first embodiment.

FIG. 6 is a diagram illustrating an example of voltage (three-phase modulation) applied to each phase, a carrier wave, a compare value, and a second gate signal in the first embodiment.

FIG. 7 is a diagram illustrating another example of voltage (three-phase modulation) applied to each phase, a carrier wave, a compare value, and a second gate signal in the first embodiment.

FIG. 8 is a diagram illustrating a current detection unit according to the first embodiment.

FIG. 9 is a diagram illustrating an example of voltage (two-phase modulation min-type) applied to each phase, a carrier wave, a compare value, and a second gate signal in a first variation of the first embodiment.

FIG. 10 is a diagram illustrating another example of voltage (two-phase modulation min-type) applied to each phase, a carrier wave, a compare value, and a second gate signal in the first variation of the first embodiment.

FIG. 11 is a diagram illustrating an example of voltage (two-phase modulation min-max-type) applied to each phase, a carrier wave, a compare value, and a second gate signal in a second variation of the first embodiment.

FIG. 12 is a diagram illustrating another example of voltage (two-phase modulation min-max-type) applied to each phase, a carrier wave, a compare value, and a second gate signal in the second variation of the first embodiment.

FIG. 13 is a block diagram illustrating the motor module according to a second embodiment of the present disclosure.

FIG. 14 is a diagram illustrating an example of a carrier wave and a compare value according to the second embodiment.

FIG. 15 is a diagram illustrating another example of a carrier wave and a compare value according to the second embodiment.

FIG. 16 is a flowchart illustrating phase determination processing for determining a phase for directly detecting current in the second embodiment.

FIG. 17 is a flowchart illustrating current value calculation processing for calculating a current value of undetected current in the second embodiment.

FIG. 18 is a diagram illustrating an example of voltage (five-phase modulation) applied to each phase, a carrier wave, and a compare value in the second embodiment.

FIG. 19 is a diagram illustrating a change in order of magnitude of a P1 phase to a P5 phase in an electrical angle range of 0 [degE] to 360 [degE] in five-phase modulation in the second embodiment.

FIG. 20 is a diagram illustrating the motor module according to a third embodiment of the present disclosure.

FIG. 21 is a diagram illustrating a current sensor unit according to the third embodiment.

FIG. 22 is a diagram illustrating the current sensor unit according to a fourth embodiment of the present disclosure.

FIG. 23 is a diagram illustrating the current detection unit according to the fourth embodiment.

### DESCRIPTION OF EMBODIMENTS

Hereinafter, an embodiment of the present disclosure will be described with reference to the drawings. In the drawings, the identical or corresponding parts will be denoted by the identical reference signs and description of such parts will not be repeated.

### First Embodiment

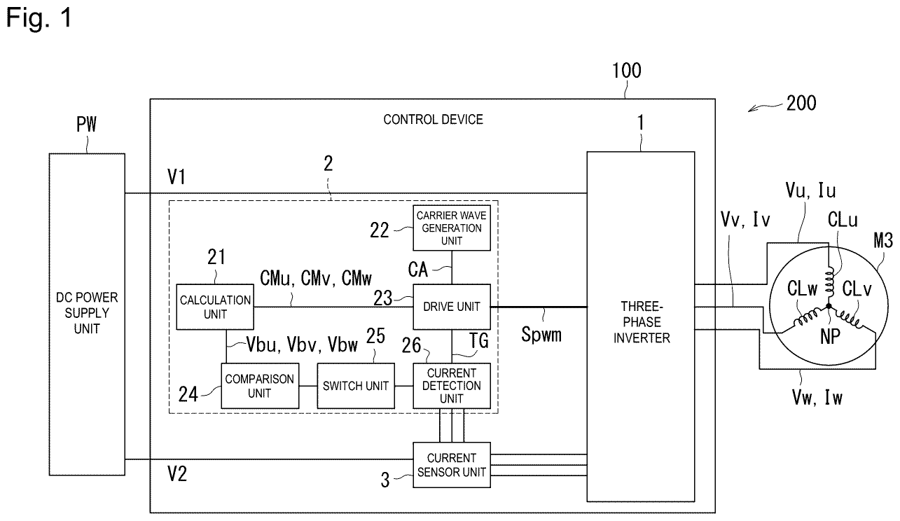

A motor module 200 according to a first embodiment of the present disclosure will be described with reference to FIGS. 1 to 8. FIG. 1 is a block diagram illustrating the motor module 200 according to the first embodiment.

As illustrated in FIG. 1, the motor module 200 includes a control device 100 and a three-phase motor M3. The control device 100 controls a three-phase inverter 1 that applies voltages Vu, Vv, and Vw to three phases. The three phases are a U phase, a V phase, and a W phase. The voltage Vu is U-phase voltage, the voltage Vv is V-phase voltage, and the voltage Vw is W-phase voltage. Hereinafter, the voltages Vu, Vv, and Vw may be referred to as the applied voltages Vu, Vv, and Vw. Note that, in the example of FIG. 1, the control device 100 includes the three-phase inverter 1. Then, the three-phase inverter 1 is connected to a DC power supply unit PW.

In the present description, as an example, the three-phase inverter 1 applies the voltages Vu, Vv, and Vw having different phases to the U phase, the V phase, and the W phase of the three-phase motor M3 to drive the three-phase motor M3. Currents Iu, Iv, and Iw corresponding to the voltages Vu, Vv, and Vw flow through the U phase, the V phase, and the W phase of the three-phase motor M3. The current Iu is U-phase current, the current Iv is V-phase current, and the current Iw is W-phase current.

The three-phase motor M3 includes coils CLu, CLv, and CLw of three phases. The coil CLu is a U-phase coil, the coil CLv is a V-phase coil, and the coil CLw is a W-phase coil. The three-phase motor M3 is, for example, a brushless DC motor. The three-phase motor M3 has a U phase, a V phase, and a W phase. Note that, regarding polarity of the currents Iu, Iv, and Iw, polarity of current in a direction flowing from the three-phase inverter 1 to a neutral point NP of the three-phase motor M3 is set to positive, and polarity of current in a direction flowing from the neutral point NP to the three-phase inverter 1 is set to negative.

Note that a driving target of the three-phase inverter 1 is not limited to the three-phase motor M3, and may be another electric device. Further, the three-phase inverter 1 may be arranged outside the control device 100.

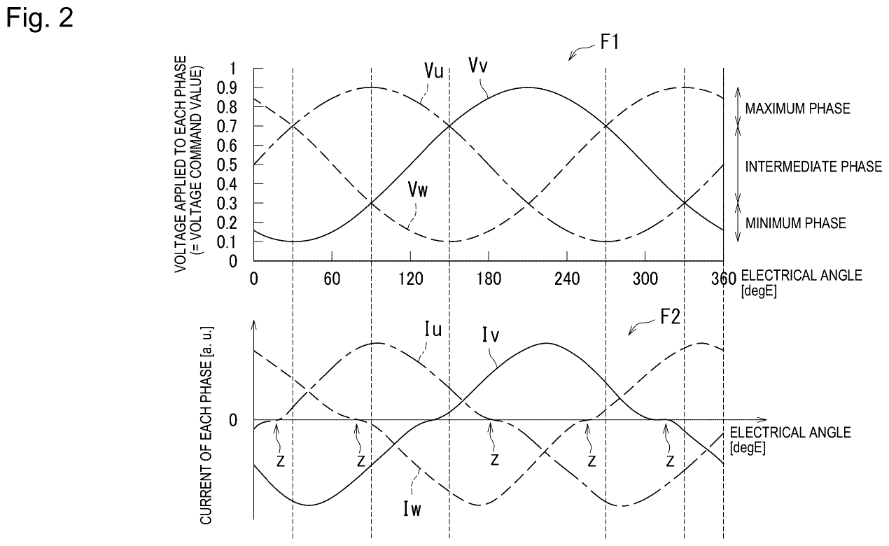

FIG. 2 is a diagram illustrating a waveform of the voltages Vu, Vv, and Vw applied to each phase and a waveform of the currents Iu, Iv, and Iw of each phase. As illustrated in FIG. 2, a waveform diagram F1 illustrates the voltages Vu, Vv, and Vw applied to each phase. In the waveform diagram F1, the horizontal axis represents an electrical angle [degE], and the vertical axis represents the voltages Vu, Vv, and Vw. For convenience of description, the vertical axis of the waveform diagram F1 represents a voltage value normalized by input voltages V1 to V2, and the voltages Vu, Vv, and Vw take a value in a range from zero to one. As illustrated in the waveform diagram F1, the voltages Vu, Vv, and Vw are sinusoidal. Phases of the voltages Vu, Vv, and Vw are different from each other. In the first embodiment, energization in a three-phase modulation system is executed.

A waveform diagram F2 illustrates the currents Iu, Iv, and Iw of each phase. In the waveform diagram F2, the horizontal axis represents an electrical angle [degE], and the vertical axis represents the currents Iu, Iv, and Iw [a.u.]. Phases of the currents Iu, Iv, and Iw are delayed with respect to phases of the voltages Vu, Vv, and Vw, respectively. From the waveform diagram F2, the currents Iu, Iv, and Iw are disturbed near zero crossing Z of the currents Iu, Iv, and Iw.

The zero crossing Z occurs in an intermediate phase of the voltages Vu, Vv, and Vw. The intermediate phase is a phase to which second largest voltage among the voltages Vu, Vv, and Vw is applied. For example, at a timing when an electrical angle is about 60 [degE], the intermediate phase is a phase (W phase) to which the second largest voltage Vw is applied. For example, at a timing when an electrical angle is about 180 [degE], the intermediate phase is a phase (U phase) to which the second largest voltage Vu is applied. For example, at a timing when an electrical angle is about 300 [degE], the intermediate phase is a phase (V phase) to which the second largest voltage Vv is applied.

In the first embodiment, among the currents Iu, Iv, and Iw, currents of two phases other than the intermediate phase are detected, and current of the intermediate phase is calculated based on current values of the currents of the two phases other than the intermediate phase. As a result, it is possible to reduce an error in current of the intermediate phase caused by the zero crossing Z or the like. Two phases other than the intermediate phase are a maximum phase and a minimum phase.

The maximum phase is a phase to which the largest one of the voltages Vu, Vv, and Vw is applied. For example, at a timing when an electrical angle is about 60 [degE], the maximum phase is a phase (U phase) to which the largest voltage Vu is applied. For example, at a timing when an electrical angle is about 180 [degE], the maximum phase is a phase (V phase) to which the largest voltage Vv is applied. For example, at a timing when an electrical angle is about 300 [degE], the maximum phase is a phase (W phase) to which the largest voltage Vw is applied.

The minimum phase is a phase to which the smallest voltage among the voltages Vu, Vv, and Vw is applied. For example, at a timing when an electrical angle is about 60 [degE], the minimum phase is a phase (V phase) to which the smallest voltage Vv is applied. For example, at a timing when an electrical angle is about 180 [degE], the minimum phase is a phase (W phase) to which the smallest voltage Vw is applied. For example, at a timing when an electrical angle is about 300 [degE], the minimum phase is a phase (U phase) to which the smallest voltage Vu is applied.

Returning to FIG. 1, the control device 100 further includes a calculation unit 21 and a current detection unit 26. When a phase to which the second largest voltage is applied at a current detection time among the voltages Vu, Vv, and Vw applied to three phases is defined as an intermediate phase, the current detection unit 26 detects currents of two phases other than the intermediate phase among the currents Iu, Iv, and Iw of the three phases. Two phases other than the intermediate phase are a maximum phase and a minimum phase. The maximum phase is a phase to which the largest one of the voltages Vu, Vv, and Vw applied to the three phases is applied at a current detection time. The minimum phase is a phase to which the smallest one of the voltages Vu, Vv, and Vw applied to the three phases is applied at a current detection time. In the first embodiment, the current detection unit 26 detects not current of the intermediate phase in which fluctuation and disturbance of current are relatively large but currents of the maximum phase and the minimum phase in which fluctuation and disturbance of current are smaller than those of the intermediate phase among the currents Iu, Iv, and Iw. Therefore, an error in a detection result is reduced for current directly detected among the currents Iu, Iv, and Iw.

Then, the calculation unit 21 calculates a current value Imid of current of an intermediate phase based on a detection result of the current detection unit 26. Specifically, the calculation unit 21 calculates the current value Imid of current of an intermediate phase from a total value Isum of a current value of current of a maximum phase and a current value of current of a minimum phase based on Kirchhoff's laws. Imid=−Isum. As described above, in the first embodiment, the calculation unit 21 calculates current of an intermediate phase from a detection result of current of a maximum phase and a minimum phase in which an error of a detection result is reduced compared to an intermediate phase among the currents Iu, Iv, and Iw. That is, current of an intermediate phase is indirectly detected. Therefore, as compared with a case where current of an intermediate phase is directly detected, it is possible to reduce an error in a detection result of current of the intermediate phase. As a result, variation in a detected value of the currents Iu, Iv, and Iw flowing through each phase can be reduced.

The control device 100 further includes a carrier wave generation unit 22, a drive unit 23, a comparison unit 24, and a switch unit 25. Specifically, the control device 100 includes an inverter control unit 2. Then, the inverter control unit 2 includes the calculation unit 21, the carrier wave generation unit 22, the drive unit 23, the comparison unit 24, the switch unit 25, and the current detection unit 26. The inverter control unit 2 is, for example, a microcomputer. The microcomputer is, for example, a hardware circuit including a processor such as a central processing unit (CPU), a semiconductor memory, an application specific integrated circuit (ASIC), an A/D converter (analog-to-digital converter, ADC), and various electronic components.

Specifically, each of the calculation unit 21, the carrier wave generation unit 22, the drive unit 23, the comparison unit 24, and the switch unit 25 may be realized by wired logic in a microcomputer, may be realized by a processor executing a computer program stored in a semiconductor memory, or may be realized by a combination of these. Further, for example, the current detection unit 26 is realized by an A/D converter.

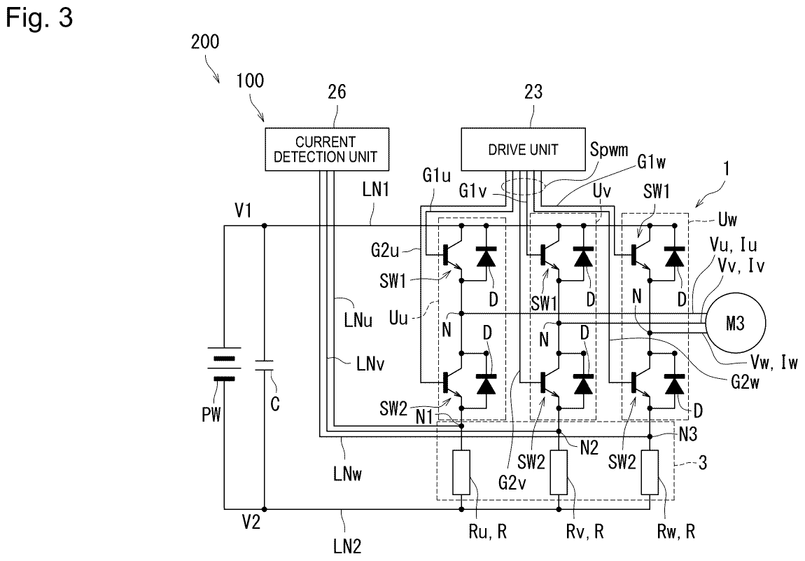

Next, the drive unit 23 and the three-phase inverter 1 will be described with reference to FIGS. 1 and 3. FIG. 3 is a circuit diagram illustrating a three-phase inverter M3. The drive unit 23 outputs a pulse width modulation (PWM) signal Spwm to the three-phase inverter 1. As a result, the three-phase inverter 1 is driven by the PWM signal Spwm. The PWM signal Spwm includes first gate signals G1u, G1v, and G1w and second gate signals G2u, G2v, and G2w.

Specifically, the three-phase inverter 1 includes three switching units Uu, Uv, and Uv. The switching units Uu, Uv, and Uv apply the voltages Vu, Vv, and Vw to three phases. Specifically, the switching units Uu, Uv, and Uv respectively apply the voltages Vu, Vv, and Vw having different phases to the coils CLu, CLv, and CLw of three phases (FIG. 1). The switching units Uu, Uv, and Uv are connected in parallel between a first power supply line LN1 and a second power supply line LN2.

Each of the switching units Uu, Uv, and Uv includes a first switching element SW1 on the first voltage V1 side of the DC power supply unit PW and a second switching element SW2 on the second voltage V2 side of the DC power supply unit PW. The second switching element SW2 is connected in series with the first switching element SW1. Specifically, the first switching element SW1 and the second switching element SW2 are connected in series between the first power supply line LN1 and the second power supply line LN2. First voltage V1 is supplied from the DC power supply unit PW to the first power supply line LN1. Second voltage V2 is supplied from the DC power supply unit PW to the second power supply line LN2. In an example of FIG. 1, the second voltage V2 is smaller than the first voltage V1. For example, the second voltage V2 is ground voltage (0 V).

Here, the control device 100 further includes three electric resistance units Ru, Rv, and Rw for detecting the currents Iu, Iv, and Iw of three phases, respectively. Each of the electric resistance units Ru, Rv, and Rw, or a generic term for these may be referred to as an electric resistance unit R. Specifically, the control device 100 includes a current sensor unit 3 for detecting the currents Iu, Iv, and Iw of three phases. Then, the current sensor unit 3 includes the electric resistance units Ru, Rv, and Rw. For this reason, the first switching element SW1 and the second switching element SW2 of the switching unit Uu and the electric resistance unit Ru are connected in series between the first power supply line LN1 and the second power supply line LN2. The first switching element SW1 and the second switching element SW2 of the switching unit Uv and the electric resistance unit Rv are connected in series between the first power supply line LN1 and the second power supply line LN2. The first switching element SW1 and the second switching element SW2 of the switching unit Uw and the electric resistance unit Rw are connected in series between the first power supply line LN1 and the second power supply line LN2.

Each of the first switching element SW1 and the second switching element SW2 is a semiconductor switching element. In the example of FIG. 3, each of the first switching element SW1 and the second switching element SW2 is an insulated gate bipolar transistor (IGBT). Each of the first switching element SW1 and the second switching element SW2 may be another transistor such as a field effect transistor.

A collector of the first switching element SW1 is connected to the first power supply line LN1. An emitter of the first switching element SW1 and a collector of the second switching element SW2 are connected at a connection point N.

The connection point N of the switching unit Uu is connected to the coil CLu (FIG. 1) of the three-phase motor M3. The connection point N of the switching unit Uv is connected to the coil CLv (FIG. 1) of the three-phase motor M3. The connection point N of the switching unit Uw is connected to the coil CLw (FIG. 1) of the three-phase motor M3.

An emitter of the second switching element SW2 of the switching unit Uu is connected to one terminal of the electric resistance unit Ru at a connection point N1. An emitter of the second switching element SW2 of the switching unit Uv is connected to one terminal of the electric resistance unit Rv at a connection point N2. An emitter of the second switching element SW2 of the switching unit Uw is connected to one terminal of the electric resistance unit Rw at a connection point N3. Another terminal of the electric resistance units Ru, Rv, Rw is connected to the second power supply line LN2.

The first gate signals G1u, G1v, and G1w are input to gates of the first switching element SW1 of the switching units Uu, Uv, and Uw, respectively. The first switching element SW1 of the switching units Uu, Uv, and Uw is turned on when the first gate signals G1u, G1v, and G1w are at a high level, respectively. The first switching element SW1 of the switching units Uu, Uv, and Uw is turned off when the first gate signals G1u, G1v, and G1w are at a low level, respectively.

The second gate signals G2u, G2v, and G2w are input to gates of the second switching element SW2 of the switching units Uu, Uv, and Uw, respectively. The second switching element SW2 of the switching units Uu, Uv, and Uw is turned on when the second gate signals G2u, G2v, and G2w are at a high level, respectively. The second switching element SW2 of the switching units Uu, Uv, and Uw is turned off when the second gate signals G2u, G2v, and G2w are at a low level, respectively.

Polarity of the second gate signals G2u, G2v, and G2w is basically opposite to polarity of the first gate signals G1u, G1v, and G1w, respectively. That is, the second gate signals G2u, G2v, and G2w and the first gate signals G1u, G1v, and G1w basically have a complementary relationship. However, regarding the first gate signals G1u, G1v, and G1w and the second gate signals G2u, G2v, and G2w, a period (dead time) in which both the first gate signal and the second gate signal are at a low level may be provided when each of the first switching element SW1 and the second switching element SW2 is switched on and off. A reason for providing the dead time is to prevent a short circuit between the first power supply line LN1 and the second power supply line LN2 due to influence of rise time and fall time required for each of the first switching element SW1 and the second switching element SW2.

The rectifier element D is connected in parallel to each of the first switching element SW1 and the second switching element SW2 with the first power supply line LN1 side as a cathode and the second power supply line LN2 side as an anode. In a case where a field effect transistor is used as the first switching element SW1 and the second switching element SW2, a parasitic diode may be used as a rectifier element.

Subsequently, the electric resistance units Ru, Rv, and Rw will be described with reference to FIG. 3. The electric resistance units Ru, Rv, and Rw are a resistance component (for example, a resistance element) for detecting the currents Iu, Iv, and Iw flowing through the coils CLu, CLv, and CLw of three phases (FIG. 1), respectively, via the three-phase inverter 1. In the first embodiment, the electric resistance units Ru, Rv, and Rw are used as a current sensor, so that the control device 100 can be realized at low cost. Each of the electric resistance units Ru, Rv, and Rw is, for example, a shunt resistor. Specifically, at each current detection time, two of the electric resistance units R out of three of the electric resistance units Ru, Rv, and Rw are used.

The electric resistance units Ru, Rv, and Rw are arranged corresponding to the switching units Uu, Uv, and Uw, respectively. The electric resistance unit Ru is arranged between the second switching element SW2 of the switching unit Uu and the DC power supply unit PW. The electric resistance unit Rv is arranged between the second switching element SW2 of the switching unit Uv and the DC power supply unit PW. The electric resistance unit Rw is arranged between the second switching element SW2 of the switching unit Uw and the DC power supply unit PW.

The control device 100 further includes signal lines LNu, LNv, and LNw. The signal line LNu extends from the connection point N1 of the electric resistance unit Ru to the current detection unit 26. The signal line LNv extends from the connection point N2 of the electric resistance unit Rv to the current detection unit 26. The signal line LNw extends from the connection point N3 of the electric resistance unit Rw to the current detection unit 26.

When detecting the current Iu, the current detection unit 26 detects a potential difference between both ends of the electric resistance unit Ru through which the current Iu flows via the signal line LNu. A potential difference between both ends of the electric resistance unit Ru is generated by a voltage drop by the electric resistance unit Ru. Then, the current detection unit 26 converts a potential difference between both ends of the electric resistance unit Ru into current to acquire a current value of the current Iu. Note that, in order to detect the current Iu by using the electric resistance unit Ru, the second switching element SW2 of the switching unit Uu needs to be turned on. Further, the calculation unit 21 may convert a potential difference between both ends of the electric resistance unit Ru into the current Iu.

When detecting the current Iv, the current detection unit 26 detects a potential difference between both ends of the electric resistance unit Rv through which the current Iv flows via the signal line LNv. Then, the current detection unit 26 converts a potential difference between both ends of the electric resistance unit Rv into current to acquire a current value of the current Iv. Note that, in order to detect the current Iv by using the electric resistance unit Rv, the second switching element SW2 of the switching unit Uv needs to be turned on. Further, the calculation unit 21 may convert a potential difference between both ends of the electric resistance unit Rv into the current Iv. Other than the above, detection of the current Iv is similar to the case of detection of the current Iu.

When detecting the current Iw, the current detection unit 26 detects a potential difference between both ends of the electric resistance unit Rw through which the current Iw flows via the signal line LNw. Then, the current detection unit 26 converts a potential difference between both ends of the electric resistance unit Rw into current to acquire a current value of the current Iw. Note that, in order to detect the current Iw by using the electric resistance unit Rw, the second switching element SW2 of the switching unit Uw needs to be turned on. Further, the calculation unit 21 may convert a potential difference between both ends of the electric resistance unit Rw into the current Iw. Other than the above, detection of the current Iw is similar to the case of detection of the current Iu.

The control device 100 further includes a capacitor C. The capacitor C is connected between the first power supply line LN1 and the second power supply line LN2. The capacitor C can stabilize power supply current from the DC power supply unit PW.

Returning to FIG. 1, the calculation unit 21 calculates voltage command values Vbu, Vbv, and Vbw corresponding to a U phase, a V phase, and a W phase, respectively. The calculation unit 21 outputs the voltage command values Vbu, Vbv, and Vbw to the comparison unit 24.

The voltage command values Vbu, Vbv, and Vbw indicate voltage values of the voltages Vu, Vv, and Vw output from the three-phase inverter 1, respectively. Therefore, the voltage command values Vbu, Vbv, and Vbw substantially coincide with voltage values of the voltages Vu, Vv, and Vw output from the three-phase inverter 1, respectively. Specifically, the voltage command values Vbu, Vbv, and Vbw indicate voltage values to be followed by the voltages Vu, Vv, and Vw respectively applied to a U phase, a V phase, and a W phase. In the present description, the voltage command values Vbu, Vbv, and Vbw and the applied voltages Vu, Vv, and Vw are substantially synonymous.

The calculation unit 21 calculates compare values CMu, CMv, and CMw based on the voltage command values Vbu, Vbv, and Vbw. Therefore, the compare values CMu, CMv, and CMw correspond to the voltage command values Vbu, Vbv, and Vbw, respectively. The compare values CMu, CMv, and CMw directly or indirectly indicate duty values of the first gate signals G1u, G1v, and G1w in the PWM signal Spwm, respectively. Specifically, a duty value indicates a ratio of ON time of the first switching element SW1 of each phase to a preset PWM period Tpwm. The PWM period Tpwm is a period of the PWM signal Spwm. Specifically, the PWM period Tpwm is a period of the first gate signals G1u, G1v, and G1w and the second gate signals G2u, G2v, and G2w. The calculation unit 21 outputs the compare values CMu, CMv, and CMw to the drive unit 23.

The carrier wave generation unit 22 generates the carrier wave CA. The carrier wave generation unit 22 outputs the carrier wave CA to the drive unit 23. The carrier wave CA is, for example, a triangular wave. Note that a waveform of the carrier wave CA is not particularly limited.

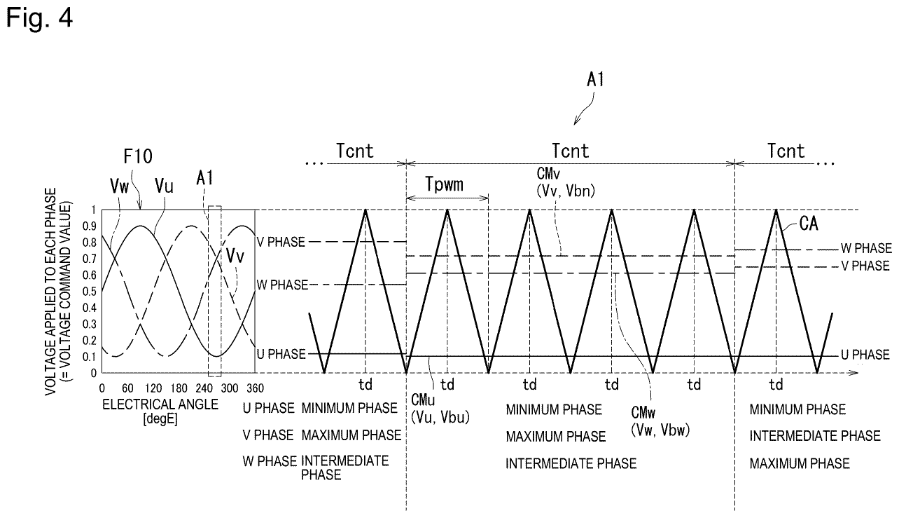

FIG. 4 is a diagram illustrating an example of the voltages Vu, Vv, and Vw, the carrier wave CA, and the compare values CMu, CMv, and CMw applied to each phase. A waveform diagram F10 of FIG. 4 illustrates the voltages Vu, Vv, and Vw applied to a U phase, a V phase, and a W phase. In the waveform diagram F10, the horizontal axis represents an electrical angle [degE], and the vertical axis represents the voltages Vu, Vv, and Vw. The vertical axis of the waveform diagram F10 represents a voltage value normalized by the input voltages V1 to V2, and the voltages Vu, Vv, and Vw take a value in a range from zero to one. Further, this value also represents a duty value, which is a ratio of ON time of the first switching element SW1 of each phase to the PWM period Tpwm. As illustrated in the waveform diagram F10, the voltages Vu, Vv, and Vw are sinusoidal. Phases of the voltages Vu, Vv, and Vw are different from each other.

In FIG. 4, the carrier wave CA and the compare values CMu, CMv, and CMw in an electrical angle range (time range) illustrated in a region A1 of the waveform diagram F10 are illustrated in a right region of the waveform diagram F10.

As illustrated in FIG. 4, the PWM period Tpwm is equal to a period of the carrier wave CA. In the example of FIG. 4, a period from a minimum point to a next minimum point of the carrier wave CA indicates the PWM period Tpwm. The PWM period Tpwm is not limited, and is, for example, 50 μs. Note that a start point and an end point of the PWM period Tpwm are not limited to a minimum point of the carrier wave CA, and can be optionally set.

Further, a control period Tcnt is defined by a period of the carrier wave CA. The control period Tcnt is a period for updating a duty value of the PWM signal Spwm. Therefore, a duty value of the PWM signal Spwm is updated for each of the control periods Tcnt. That is, the compare values CMu, CMv, and CMw and the voltage command values Vbu, Vbv, and Vbw are updated for each of the control periods Tcnt. The control period Tcnt is longer than the PWM period Tpwm. In the example of FIG. 4, the control period Tcnt is an integral multiple of the PWM period Tpwm. However, the control period Tcnt does not need to be an integral multiple of a PWM period Tpw. The compare values CMu, CMv, and CMw determined for each of the control periods Tcnt may be updated, for example, at a timing determined by a microcomputer used as the inverter control unit 2. In this case, a timing determined by a microcomputer is, for example, a minimum point of the carrier wave CA. Note that the control period Tcnt is not particularly limited, and is, for example, 200 μs. In the example of FIG. 4, a start point and an end point of the control period Tcnt are a minimum point of the carrier wave CA. Note that a start point and an end point of the control period Tcnt are not limited to a minimum point of the carrier wave CA, and can be optionally set.

Returning to FIG. 1, the drive unit 23 generates the PWM signal Spwm based on the carrier wave CA and the compare values CMu, CMv, and CMw. Specifically, the drive unit 23 compares each of the compare values CMu, CMv, and CMw with the carrier wave CA, and generates the PWM signal Spwm based on a comparison result. Details will be described later. Then, the drive unit 23 outputs the PWM signal Spwm to the three-phase inverter 1 to drive the three-phase inverter 1. As a result, the three-phase inverter 1 applies the voltages Vu, Vv, and Vw indicated by the voltage command values Vbu, Vbv, and Vbw to the coils CLu, CLv, and CLw of three phases, respectively.

Further, the drive unit 23 generates a trigger TG in synchronization with the carrier wave CA and outputs the trigger TG to the current detection unit 26. The trigger TG indicates arrival of a current detection time to the current detection unit 26. For example, the drive unit 23 generates the trigger TG at a timing when a maximum point is generated in the carrier wave CA, and outputs the trigger TG to the current detection unit 26. Note that an event for generating the trigger TG is not limited to a maximum point, and can be optionally set.

The current detection unit 26 detects current via the current sensor unit 3 in response to the trigger TG generated by the drive unit 23. A time when the trigger TG is generated is a current detection time. Specifically, as illustrated in FIG. 4, at a current detection time td synchronized with the carrier wave CA for generating the PWM signal Spwm, the current detection unit 26 detects current of each phase flowing through two of the electric resistance units R connected to two of the second switching elements SW2 (FIG. 3) that are turned on. In the example of FIG. 4, the current detection time td is a time when a maximum point of the carrier wave CA is generated. Note that, in the present description, an electrical angle [degE] can be regarded as representing time by an angle.

Here, in the example of FIG. 4, for convenience of description, a magnitude relationship between the compare values CMu, CMv, and CMw and a magnitude relationship between the voltage command values Vbu, Vbv, and Vbw (applied voltages Vu, Vv, and Vw) are matched with each other. Therefore, regarding description of the comparison unit 24 of FIG. 1, for convenience, in FIG. 4, a straight line indicating the compare values CMu, CMv, and CMw is regarded as a straight line indicating the voltage command values Vbu, Vbv, and Vbw (applied voltages Vu, Vv, and Vw).

The comparison unit 24 compares the voltage command values Vbu, Vbv, and Vbw of three phases with each other at each of the current detection times td, and determines the order of magnitude of the voltage command values Vbu, Vbv, and Vbw. In other words, the comparison unit 24 compares the voltages Vu, Vv, and Vw to be applied to a U phase, a V phase, and a W phase, respectively, with each other at each of the current detection times td, and determines the order of magnitude of the voltages Vu, Vv, and Vw. Furthermore, in other words, the comparison unit 24 determines an intermediate phase, a maximum phase, and a minimum phase from a U phase, a V phase, and a W phase. For example, in the control period Tcnt in the center of FIG. 4, a W phase is an intermediate phase, a V phase is a maximum phase, and a U phase is a minimum phase.

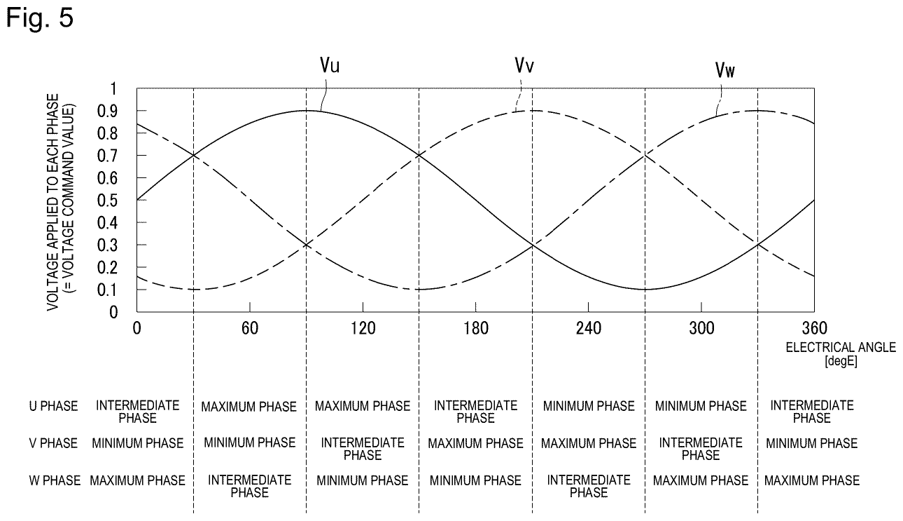

FIG. 5 is a diagram illustrating transition of an intermediate phase, a maximum phase, and a minimum phase in an electrical angle range of 0 [degE] to 360 [degE]. The horizontal axis and the vertical axis in FIG. 5 are similar to the horizontal axis and the vertical axis in the waveform diagram F10 illustrated in FIG. 4. In the example of FIG. 5, a combination of an intermediate phase, a maximum phase, and a minimum phase changes every 60 [degE]. For example, in an electrical angle range of 150 [degE] to 210 [degE], the comparison unit 24 determines a U phase as an intermediate phase, a V phase as a maximum phase, and a W phase as a minimum phase.

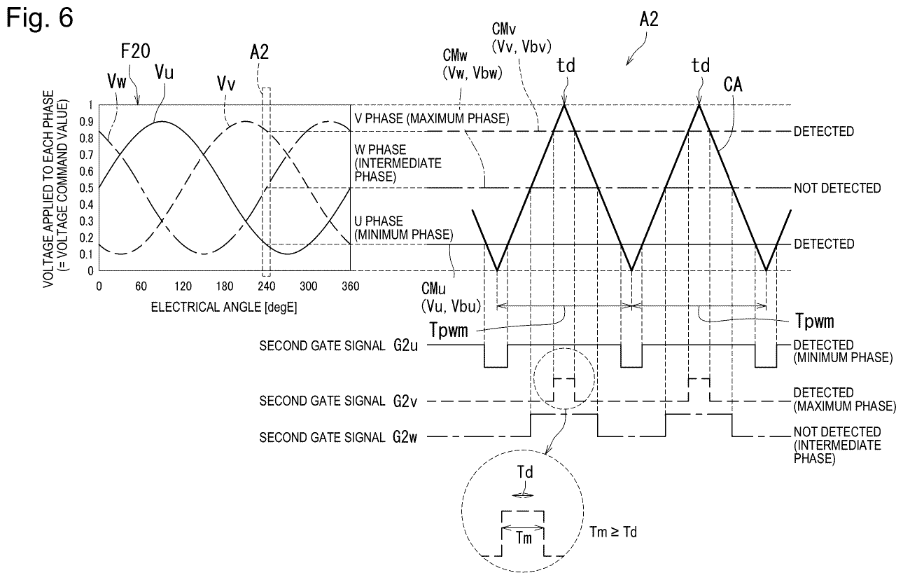

Next, the drive unit 23, the comparison unit 24, the switch unit 25, and the current detection unit 26 will be described with reference to FIGS. 1, 6, and 7. FIG. 6 is a diagram illustrating an example of the voltages Vu, Vv, and Vw applied to each phase, the carrier wave CA, the compare values CMu, CMv, and CMw, and the second gate signals G2u, G2v, and G2w. A waveform diagram F20 of FIG. 6 illustrates the voltages Vu, Vv, and Vw applied to a U phase, a V phase, and a W phase. The horizontal axis and the vertical axis of the waveform diagram F20 are similar to the horizontal axis and the vertical axis of the waveform diagram F10 of FIG. 4.

In FIG. 6, the carrier wave CA and the compare values CMu, CMv, and CMw in an electrical angle range (time range) illustrated in a region A2 of the waveform diagram F10 are illustrated in a right region of the waveform diagram F20. Further, the second gate signals G2u, G2v, and G2w to be applied to the second switching element SW of the switching units Uu, Uv, and Uw, respectively, are illustrated corresponding to the carrier wave CA and the compare values CMu, CMv, and CMw. Note that, in description of the comparison unit 24, also in FIG. 6, similarly to the case of FIG. 4, for convenience, a straight line indicating the compare values CMu, CMv, and CMw is regarded as a straight line indicating the voltage command values Vbu, Vbv, and Vbw (applied voltages Vu, Vv, and Vw).

As illustrated in FIG. 6, the drive unit 23 compares the compare value CMu with the carrier wave CA, compares the compare value CMv with the carrier wave CA, and compares the compare value CMw with the carrier wave CA in each of the PWM periods Tpwm. As a result, the first gate signals G1u, G1v, and G1w and the second gate signals G2u, G2v, and G2w are generated. In the first embodiment, the drive unit 23 generates the first gate signals G1u, G1v, and G1w and the second gate signals G2u, G2v, and G2w by a center alignment method.

In the example of FIG. 6, in a case where the compare value CMu is less than a level of the carrier wave CA, the drive unit 23 sets the second gate signal G2u to a high level (sets the first gate signal G1u to a low level). On the other hand, in a case where the compare value CMu is equal to or more than a level of the carrier wave CA, the drive unit 23 sets the second gate signal G2u to a low level (sets the first gate signal G1u to a high level).

Similarly, in the example of FIG. 6, in a case where the compare value CMv is less than a level of the carrier wave CA, the drive unit 23 sets the second gate signal G2v to a high level (sets the first gate signal G1v to a low level). On the other hand, in a case where the compare value CMv is equal to or more than a level of the carrier wave CA, the drive unit 23 sets the second gate signal G2v to a low level (sets the first gate signal G1v to a high level).

Similarly, in the example of FIG. 6, in a case where the compare value CMw is less than a level of the carrier wave CA, the drive unit 23 sets the second gate signal G2w to a high level (sets the first gate signal G1w to a low level). On the other hand, in a case where the compare value CMw is equal to or more than a level of the carrier wave CA, the drive unit 23 sets the second gate signal G2w to a low level (sets the first gate signal G1w to a high level).

The comparison unit 24 determines an intermediate phase, a maximum phase, and a minimum phase based on a comparison result of the voltage command values Vbu, Vbv, and Vbw for each of the current detection times td. In the example of FIG. 6, at the current detection time td, the intermediate phase is a W phase corresponding to the voltage command value Vbw, the maximum phase is a V phase corresponding to the voltage command value Vbv, and the minimum phase is a U phase corresponding to the voltage command value Vbu.

In the example of FIG. 6, for each of the current detection times td, the switch unit 25 determines whether or not a period Tm during which the second switching element SW2 of the switching unit Uv for applying voltage to the maximum phase (V phase) is turned on is shorter than the period Td set in advance for detection of current by the current detection unit 26. In the example of FIG. 6, the switch unit 25 determines that the period Tm is equal to or more than the period Td.

As a result, in the example of FIG. 6, the current detection unit 26 detects the current Iv of the maximum phase (V phase) and the current Iu of the minimum phase (U phase) other than the intermediate phase (W phase) via the electric resistance units Rv and Ru, respectively, at the current detection time td. Note that, at the current detection time td, since the second gate signals G2u and G2v are at a high level, the second switching element SW2 of the switching units Uu and Uv is turned on. Therefore, the currents Iu and Iv flow through the electric resistance units Ru and Rv, respectively.

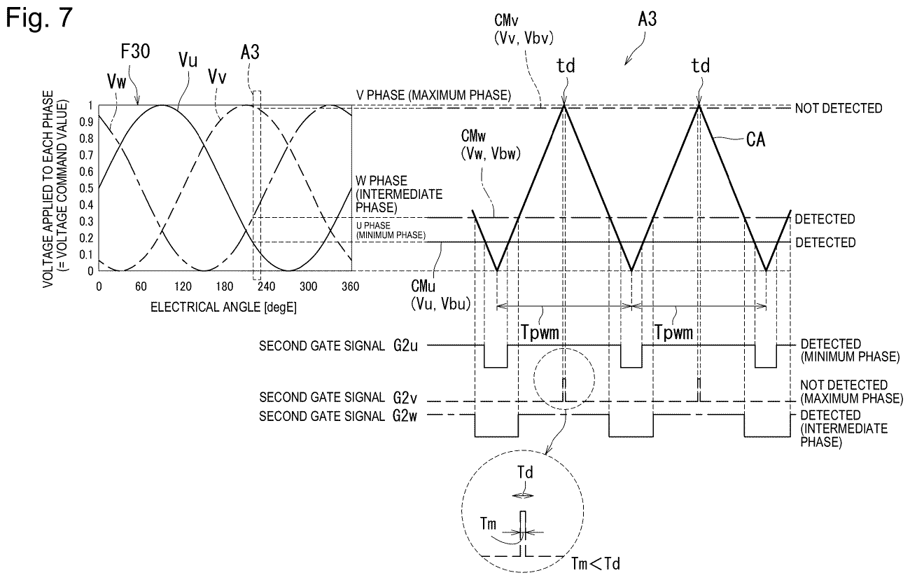

FIG. 7 is a diagram illustrating another example of the voltages Vu, Vv, and Vw applied to each phase, the carrier wave CA, the compare values CMu, CMv, and CMw, and the second gate signals G2u, G2v, and G2w. A waveform diagram F30 of FIG. 7 illustrates the voltages Vu, Vv, and Vw applied to a U phase, a V phase, and a W phase. The horizontal axis and the vertical axis of the waveform diagram F30 are similar to the horizontal axis and the vertical axis of the waveform diagram F20 of FIG. 6. In FIG. 7, the carrier wave CA and the compare values CMu, CMv, and CMw in an electrical angle range (time range) illustrated in a region A3 of the waveform diagram F30 are illustrated in a right region of the waveform diagram F30. Other than the above, a way of viewing FIG. 7 is similar to a way of viewing FIG. 6.

As illustrated in the example of FIG. 7, in a case where the switch unit 25 determines that the period Tm in which the second switching element SW2 of the switching unit Uv for applying the voltage Vv to the maximum phase (V phase) is turned on is shorter than the period Td set in advance for detection of current by the current detection unit 26 within the PWM period Tpwm, the current detection unit 26 detects the current Iw of the intermediate phase (W phase) instead of the maximum phase (V phase), and the calculation unit 21 calculates a current value of the current Iv of the maximum phase (V phase) based on a detection result of the current Iw of the intermediate phase (W phase) and the current Iu of the minimum phase (U phase).

As described above with reference to FIG. 7, in a case where detection of current of a maximum phase by the current detection unit 26 is not possible because a duty value of a first gate signal (in the example of FIG. 7, the first gate signal G1v) applied to the first switching element SW1 of the maximum phase is near 100%, the current is substituted with current of an intermediate phase, so that a current value of the currents Iu, Iv, and Iw of three phases can be detected. Specifically, the calculation unit 21 calculates a current value Imax of current of a maximum phase from the total value Isum of a current value of current of a minimum phase and a current value of current of an intermediate phase based on Kirchhoff's laws. Imax=−Isum.

Note that, within a PWM period Twpm, the period Tm during which the second switching element SW2 of a maximum phase is turned on is shorter than the period Td, which means that a period during which the first switching element SW1 of the maximum phase is turned on within the PWM period Twpm is long. In this case, a duty value of the first gate signal (in the example of FIG. 7, the first gate signal G1v) applied to the first switching element SW1 of the maximum phase is near 100%.

Further, at the current detection time td, since the second gate signals G2u and G2w are at a high level, the second switching element SW2 of the switching units Uu and Uw is turned on. Therefore, the currents Iu and Iw flow through the electric resistance units Ru and Rw, respectively. As a result, the current detection unit 26 can detect the currents Iu and Iw via the electric resistance units Ru and Rw.

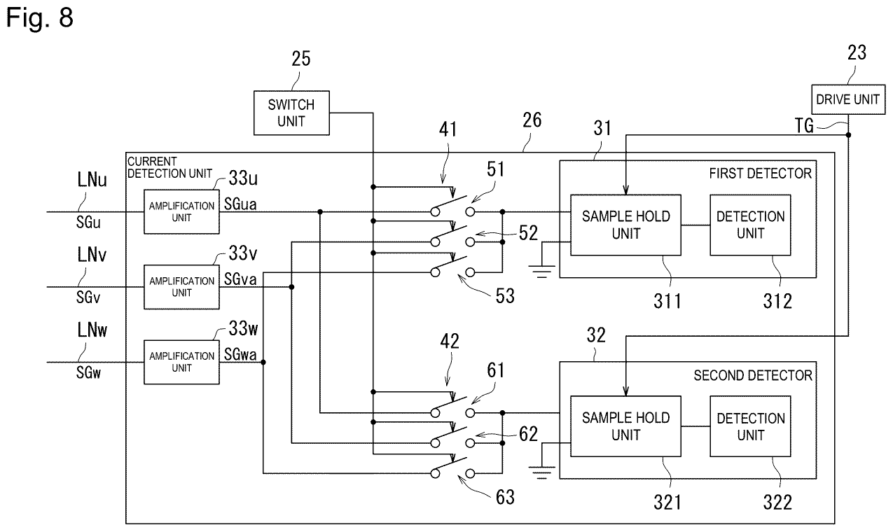

Next, the current detection unit 26 will be described with reference to FIG. 8. FIG. 8 is a diagram illustrating the current detection unit 26. As illustrated in FIG. 8, the current detection unit 26 includes a first detector 31, a second detector 32, an amplification unit 33u, an amplification unit 33v, an amplification unit 33w, a first selection unit 41, and a second selection unit 42. The first detector 31 includes a sample hold unit 311 and a detection unit 312. The second detector 32 includes a sample hold unit 321 and a detection unit 322. The first selection unit 41 includes three switching elements 51, 52, and 53. The second selection unit 42 includes three switching elements 61, 62, and 63.

At a current detection time, when a phase to which largest voltage among the voltages Vu, Vv, and Vw applied to three phases is applied is set as a maximum phase, the first detector 31 detects current of the maximum phase among the currents Iu, Iv, and Iw of the three phases. On the other hand, at the current detection time, when the phase to which the smallest voltage among the voltages Vu, Vv, and Vw applied to the three phases is applied is the minimum phase, the second detector 32 detects the current of the minimum phase among the currents Iu, Iv, and Iw of three phases.

As described above with reference to FIG. 8, according to the first embodiment, as dedicated detectors (the first detector 31 and the second detector 32) are provided for a maximum phase and a minimum phase, current detected by each detector is stable in an entire detection period. As a result, current detection accuracy can be improved in an entire detection period. Further, a current value of the currents Iu, Iv, and Iw of three phases can be acquired by two detectors.

Specifically, as illustrated in FIGS. 3 and 8, the signal lines LNu, LNv, and LNw are connected to the amplification units 33u, 33v, and 33w, respectively.

In a case where the second switching element SW2 of the switching unit Uu is in an on state at a current detection time, a voltage signal SGu according to the current Iu flowing through the electric resistance unit Ru is input from the signal line LNu to the amplification unit 33u. That is, the voltage signal SGu at a level corresponding to a potential difference between both ends of the electric resistance unit Ru is input from the signal line LNu to the amplification unit 33u.

The amplification unit 33u amplifies the voltage signal SGu and outputs an amplified voltage signal SGua to the first selection unit 41 and the second selection unit 42. The amplification unit 33u includes, for example, an amplifier such as an operational amplifier.

In a case where the second switching element SW2 of the switching unit Uv is in an on state at a current detection time, a voltage signal SGv according to the current Iv flowing through the electric resistance unit Rv is input from the signal line LNv to the amplification unit 33v. That is, the voltage signal SGv at a level corresponding to a potential difference between both ends of the electric resistance unit Rv is input from the signal line LNv to the amplification unit 33v.

The amplification unit 33v amplifies the voltage signal SGv and outputs an amplified voltage signal SGva to the first selection unit 41 and the second selection unit 42. The amplification unit 33v includes, for example, an amplifier such as an operational amplifier.

In a case where the second switching element SW2 of the switching unit Uw is in an on state at a current detection time, a voltage signal SGw according to the current Iw flowing through the electric resistance unit Rw is input from the signal line LNw to the amplification unit 33w. That is, the voltage signal SGw at a level corresponding to a potential difference between both ends of the electric resistance unit Rw is input from the signal line LNw to the amplification unit 33w.

The amplification unit 33w amplifies the voltage signal SGw and outputs an amplified voltage signal SGwa to the first selection unit 41 and the second selection unit 42. The amplification unit 33w includes, for example, an amplifier such as an operational amplifier.

Under control of the switch unit 25, the first selection unit 41 selects any one of the amplification units 33u, 33v, and 33w, and connects the selected amplification unit to the sample hold unit 311 of the first detector 31. Specifically, the switching element 51 electrically connects or separates the amplification unit 33u and the sample hold unit 311 under control of the switch unit 25. The switching element 52 electrically connects or separates the amplification unit 33v and the sample hold unit 311 under control of the switch unit 25. The switching element 53 electrically connects or separates the amplification unit 33w and the sample hold unit 311 under control of the switch unit 25.

Under control of the switch unit 25, the second selection unit 42 selects any one of the amplification units 33u, 33v, and 33w, and connects the selected amplification unit to the sample hold unit 321 of the second detector 32. Specifically, the switching element 61 electrically connects or separates the amplification unit 33u and the sample hold unit 321 under control of the switch unit 25. The switching element 62 electrically connects or separates the amplification unit 33v and the sample hold unit 321 under control of the switch unit 25. The switching element 63 electrically connects or separates the amplification unit 33w and the sample hold unit 321 under control of the switch unit 25.

The switch unit 25 controls the first selection unit 41 and the second selection unit 42. Specifically, in a case of determining to detect current of a maximum phase and a minimum phase, the switch unit 25 controls the first selection unit 41 so that a voltage signal representing a current value of current of the maximum phase among the voltage signals SGua, SGva, and SGwa is input to the sample hold unit 311 of the first detector 31. As a result, the first selection unit 41 inputs only a voltage signal representing a current value of current of the maximum phase to the sample hold unit 311. Then, in response to the trigger TG of the drive unit 23, the sample hold unit 311 starts sampling of a voltage signal representing a current value of current of the maximum phase.

Then, the sample hold unit 311 ends sampling of a voltage signal when the period Td elapses from start of the sampling. The period Td is preset in the current detection unit 26 and is an essential period required for the first detector 31 to detect current. The sample hold unit 311 is, for example, a sample hold circuit including an element such as a capacitor.

The detection unit 312 converts a voltage signal sampled by the sample hold unit 311 into a digital signal. That is, the detection unit 312 converts a voltage signal indicating a potential difference between both ends of the electric resistance unit R into a digital signal, and outputs the digital signal to the calculation unit 21. The calculation unit 21 converts a potential difference between both ends of the electric resistance unit R indicated by the digital signal into a current value, and acquires a current value of current of a maximum phase. In this manner, the detection unit 312 detects current of a maximum phase.

In addition, in a case of determining to detect current of a maximum phase and a minimum phase, the switch unit 25 controls the second selection unit 42 so that a voltage signal representing a current value of current of the minimum phase among the voltage signals SGua, SGva, and SGwa is input to the sample hold unit 321 of the second detector 32. As a result, the second selection unit 42 inputs only a voltage signal representing a current value of current of the minimum phase to the sample hold unit 321. Then, in response to the trigger TG of the drive unit 23, the sample hold unit 321 starts sampling of a voltage signal representing a current value of current of the minimum phase.

Then, the sample hold unit 321 ends sampling of a voltage signal when the period Td elapses from start of the sampling. The period Td is preset in the current detection unit 26 and is an essential period required for the second detector 32 to detect current. The sample hold unit 321 is, for example, a sample hold circuit including an element such as a capacitor.

The detection unit 322 converts a voltage signal sampled by the sample hold unit 321 into a digital signal. That is, the detection unit 322 converts a voltage signal indicating a potential difference between both ends of the electric resistance unit R into a digital signal, and outputs the digital signal to the calculation unit 21. The calculation unit 21 converts a potential difference between both ends of the electric resistance unit R indicated by the digital signal into a current value, and acquires a current value of current of a minimum phase. In this manner, the detection unit 322 detects current of a minimum phase.

On the other hand, in a case of determining to detect current of an intermediate phase and a minimum phase, the switch unit 25 controls the first selection unit 41 so that a voltage signal representing a current value of current of the intermediate phase among the voltage signals SGua, SGva, and SGwa is input to the sample hold unit 311 of the first detector 31. Then, in response to the trigger TG of the drive unit 23, the sample hold unit 311 starts sampling of a voltage signal representing a current value of current of the intermediate phase.

Then, the sample hold unit 311 ends sampling of a voltage signal when the period Td elapses from start of the sampling.

The detection unit 312 converts a voltage signal sampled by the sample hold unit 311 into a digital signal. That is, the detection unit 312 converts a voltage signal indicating a potential difference between both ends of the electric resistance unit R into a digital signal, and outputs the digital signal to the calculation unit 21. The calculation unit 21 converts a potential difference between both ends of the electric resistance unit R indicated by the digital signal into a current value, and acquires a current value of current of an intermediate phase. In this manner, the detection unit 312 detects current of an intermediate phase.

In addition, in a case of determining to detect current of an intermediate phase and a minimum phase, the switch unit 25 controls the second selection unit 42 so that a voltage signal representing a current value of current of the minimum phase among the voltage signals SGua, SGva, and SGwa is input to the sample hold unit 321 of the second detector 32. Other than the above, current detection processing of a minimum phase in a case where current of an intermediate phase and a minimum phase is determined to be detected is similar to the current detection processing of a minimum phase in a case where current of a maximum phase and a minimum phase is determined to be detected.

Note that each of the detection units 312 and 322 is, for example, an A/D converter. However, each of the first detector 31 and the second detector 32 may be an A/D converter. Further, each of the detection units 312 and 322 may convert a potential difference between both ends of the electric resistance unit R into a current value.

### (First Variation)

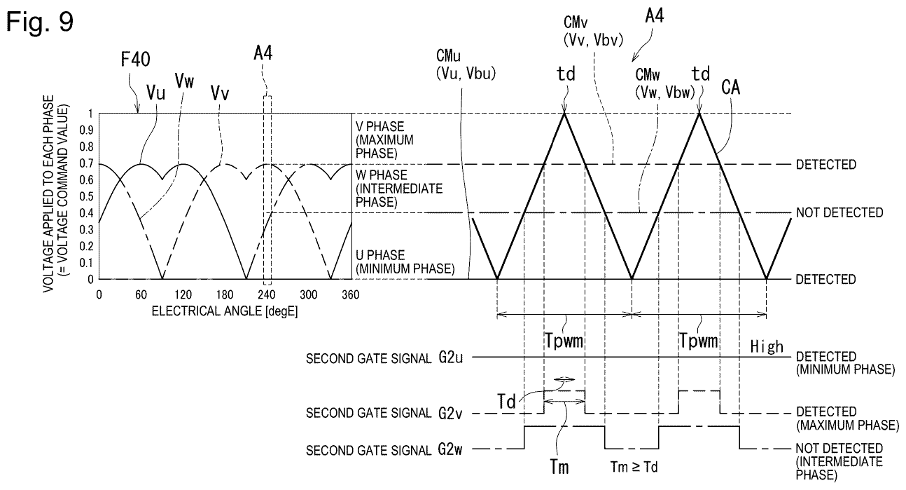

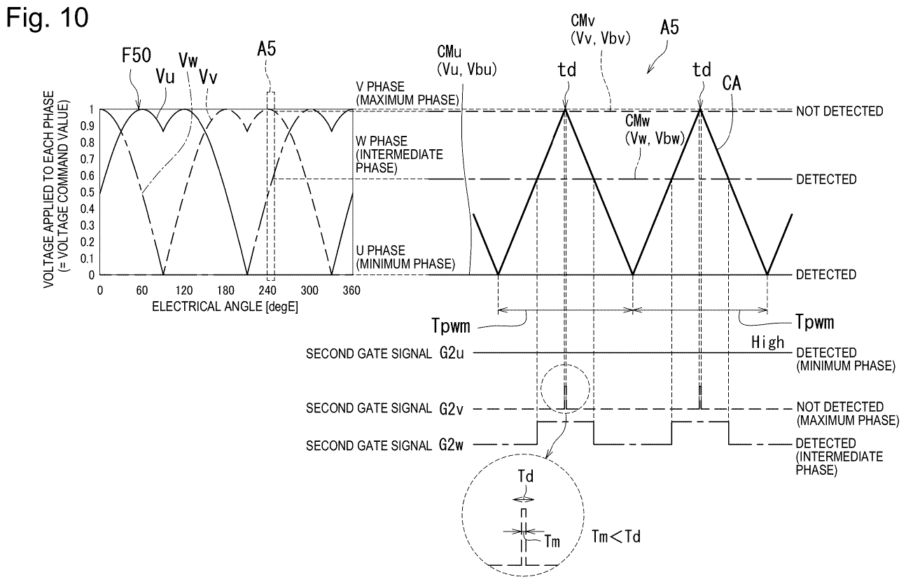

A first variation of the first embodiment will be described with reference to FIGS. 9 and 10. The first variation is mainly different from the first embodiment in which energization in three-phase modulation is executed in that a two-phase modulation min-type modulation system is employed. A different point between the first variation and the first embodiment will mainly be described below.

A waveform diagram F40 of FIG. 9 illustrates the voltages Vu, Vv, and Vw applied to a U phase, a V phase, and a W phase. The horizontal axis and the vertical axis of the waveform diagram F20 are similar to the horizontal axis and the vertical axis of the waveform diagram F10 of FIG. 4. As illustrated in the waveform diagram F40, the two-phase modulation min-type modulation system is a modulation system having a period during which one phase among three phases is fixed to be turned off in a waveform of the voltages Vu, Vv, and Vw applied to each phase. The control device 100 according to the first variation executes energization in a two-phase modulation min-type modulation system.

In FIG. 9, the carrier wave CA and the compare values CMu, CMv, and CMw in an electrical angle range (time range) illustrated in a region A4 of the waveform diagram F40 are illustrated in a right region of the waveform diagram F40. Other than the above, a way of viewing FIG. 9 is similar to a way of viewing FIG. 6.

The comparison unit 24 determines an intermediate phase, a maximum phase, and a minimum phase based on a comparison result of the voltage command values Vbu, Vbv, and Vbw for each of the current detection times td. In the example of FIG. 9, at the current detection time td, the intermediate phase is a W phase corresponding to the voltage command value Vbw, the maximum phase is a V phase corresponding to the voltage command value Vbv, and the minimum phase is a U phase corresponding to the voltage command value Vbu.

In the example of FIG. 9, for each of the current detection times td, the switch unit 25 determines whether or not the period Tm during which the second switching element SW2 of the switching unit Uv for applying voltage to the maximum phase (V phase) is turned on is shorter than the period Td set in advance for detection of current by the current detection unit 26. In the example of FIG. 9, the switch unit 25 determines that the period Tm is equal to or more than the period Td.

As a result, in the example of FIG. 9, the current detection unit 26 detects the current Iv of the maximum phase (V phase) and the current Iu of the minimum phase (U phase) other than the intermediate phase (W phase) via the electric resistance units Rv and Ru, respectively, at the current detection time td. Then, the calculation unit 21 calculates the current Iw of the intermediate phase based on the current Iv of the maximum phase and the current Iu of the minimum phase. Therefore, according to the first variation, even in a case where a two-phase modulation min-type modulation system is employed, it is possible to reduce variation in a detection value of the currents Iu, Iv, and Iw flowing through each phase as compared with a case where current of an intermediate phase is directly detected.

FIG. 10 is a diagram illustrating another example of the voltages Vu, Vv, and Vw (two-phase modulation min-type) applied to each phase, the carrier wave CA, the compare values CMu, CMv, and CMw, and the second gate signals G2u, G2v, and G2w. A waveform diagram F50 of FIG. 10 illustrates the voltages Vu, Vv, and Vw applied to a U phase, a V phase, and a W phase. The horizontal axis and the vertical axis of the waveform diagram F50 are similar to the horizontal axis and the vertical axis of the waveform diagram F20 of FIG. 6. In FIG. 10, the carrier wave CA and the compare values CMu, CMv, and CMw in an electrical angle range (time range) illustrated in a region A5 of the waveform diagram F50 are illustrated in a right region of the waveform diagram F50. Other than the above, a way of viewing FIG. 10 is similar to a way of viewing FIG. 6.

As illustrated in the example of FIG. 10, in a case where the switch unit 25 determines that the period Tm in which the second switching element SW2 of the switching unit Uv for applying the voltage Vv to the maximum phase (V phase) is turned on is shorter than the period Td set in advance for detection of current by the current detection unit 26 within the PWM period Tpwm, the current detection unit 26 detects the current Iw of the intermediate phase (W phase) instead of the maximum phase (V phase), and the calculation unit 21 calculates a current value of the current Iv of the maximum phase (V phase) based on a detection result of the current Iw of the intermediate phase (W phase) and the current Iu of the minimum phase (U phase).

As described above with reference to FIG. 10, according to the first variation, in a two-phase modulation min-type modulation system, in a case where detection of current of a maximum phase by the current detection unit 26 is not possible because a duty value of a first gate signal (in the example of FIG. 10, the first gate signal G1v) applied to the first switching element SW1 of the maximum phase is near 100%, the current is substituted with current of an intermediate phase, so that a current value of the currents Iu, Iv, and Iw of three phases can be detected.

### (Second Variation)

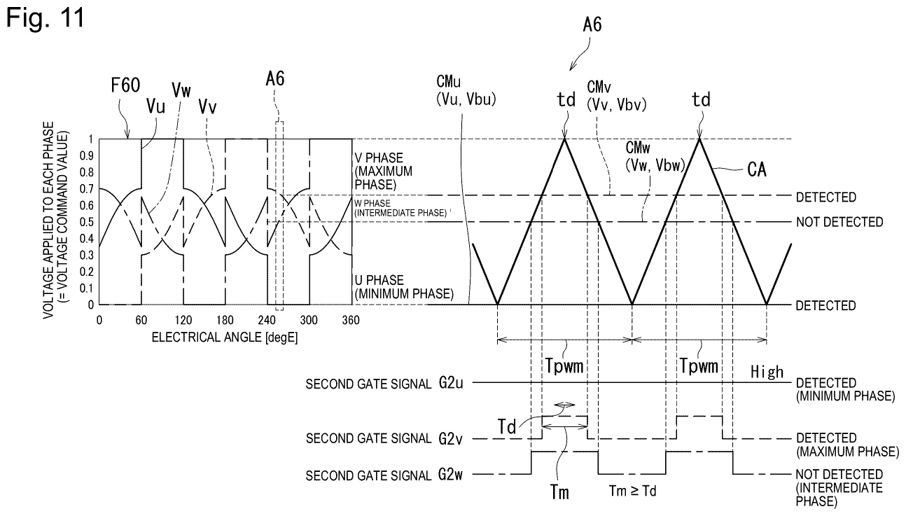

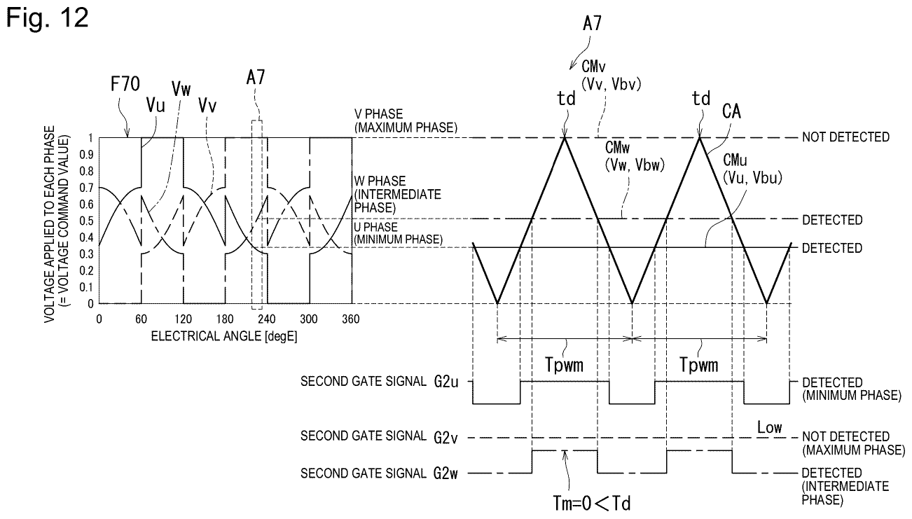

A second variation of the first embodiment will be described with reference to FIGS. 11 and 12. The second variation is mainly different from the first embodiment in which energization in three-phase modulation is executed in that a two-phase modulation min-max-type modulation system is employed. A different point between the second variation and the first embodiment will mainly be described below.

A waveform diagram F60 of FIG. 11 illustrates the voltages Vu, Vv, and Vw applied to a U phase, a V phase, and a W phase. The horizontal axis and the vertical axis of the waveform diagram F60 are similar to the horizontal axis and the vertical axis of the waveform diagram F10 of FIG. 4. As illustrated in the waveform diagram F60, the two-phase modulation min-max-type modulation system is a modulation system having a period during which one phase among three phases is fixed to be turned on and a period during which one phase among three phases is fixed to be turned off in a waveform of the voltages Vu, Vv, and Vw applied to each phase. The control device 100 according to the second variation executes energization in a two-phase modulation min-max-type modulation system.

In FIG. 11, the carrier wave CA and the compare values CMu, CMv, and CMw in an electrical angle range (time range) illustrated in a region A6 of the waveform diagram F60 are illustrated in a right region of the waveform diagram F60. Other than the above, a way of viewing FIG. 11 is similar to a way of viewing FIG. 6.

The comparison unit 24 determines an intermediate phase, a maximum phase, and a minimum phase based on a comparison result of the voltage command values Vbu, Vbv, and Vbw for each of the current detection times td. In the example of FIG. 11, at the current detection time td, the intermediate phase is a W phase corresponding to the voltage command value Vbw, the maximum phase is a V phase corresponding to the voltage command value Vbv, and the minimum phase is a U phase corresponding to the voltage command value Vbu.

In the example of FIG. 11, for each of the current detection times td, the switch unit 25 determines whether or not the period Tm during which the second switching element SW2 of the switching unit Uv for applying voltage to the maximum phase (V phase) is turned on is shorter than the period Td set in advance for detection of current by the current detection unit 26. In the example of FIG. 11, the switch unit 25 determines that the period Tm is equal to or more than the period Td.

As a result, in the example of FIG. 11, the current detection unit 26 detects the current Iv of the maximum phase (V phase) and the current Iu of the minimum phase (U phase) other than the intermediate phase (W phase) via the electric resistance units Rv and Ru, respectively, at the current detection time td. Then, the calculation unit 21 calculates the current Iw of the intermediate phase based on the current Iv of the maximum phase and the current Iu of the minimum phase. Therefore, according to the second variation, even in a case where a two-phase modulation min-max-type modulation system is employed, it is possible to reduce variation in a detection value of the currents Iu, Iv, and Iw flowing through each phase as compared with a case where current of an intermediate phase is directly detected.

FIG. 12 is a diagram illustrating another example of the voltages Vu, Vv, and Vw applied to each phase, the carrier wave CA, the compare values CMu, CMv, and CMw, and the second gate signals G2u, G2v, and G2w. A waveform diagram F70 of FIG. 12 illustrates the voltages Vu, Vv, and Vw applied to a U phase, a V phase, and a W phase. The horizontal axis and the vertical axis of the waveform diagram F70 are similar to the horizontal axis and the vertical axis of the waveform diagram F20 of FIG. 6. In FIG. 12, the carrier wave CA and the compare values CMu, CMv, and CMw in an electrical angle range (time range) illustrated in a region A7 of the waveform diagram F70 are illustrated in a right region of the waveform diagram F70. Other than the above, a way of viewing FIG. 12 is similar to a way of viewing FIG. 6.

In the example of FIG. 12, in a two-phase modulation min-max-type modulation system, the second gate signal G2v is at a zero level. Therefore, at the current detection time td, the second switching element SW2 of the switching unit Uv is turned off. As a result, the switch unit 25 determines that the period Tm in which the second switching element SW2 of the switching unit Uv for applying the voltage Vv to a maximum phase (V phase) is turned on is shorter than the period Td set in advance for detection of current by the current detection unit 26 within the PWM period Tpwm. Therefore, the current detection unit 26 detects the current Iw of an intermediate phase (W phase) instead of a maximum phase (V phase), and the calculation unit 21 calculates a current value of the current Iv of a maximum phase (V phase) based on a detection result of the current Iw of an intermediate phase (W phase) and the current Iu of a minimum phase (U phase).

As described above with reference to FIG. 12, according to the second variation, in a two-phase modulation min-max-type modulation system, in a case where detection of current of a maximum phase by the current detection unit 26 is not possible because a duty value of a first gate signal (in the example of FIG. 12, the first gate signal G1v) applied to the first switching element SW1 of the maximum phase is 100%, the current is substituted with current of an intermediate phase, so that a current value of the currents Iu, Iv, and Iw of three phases can be detected.

### Second Embodiment

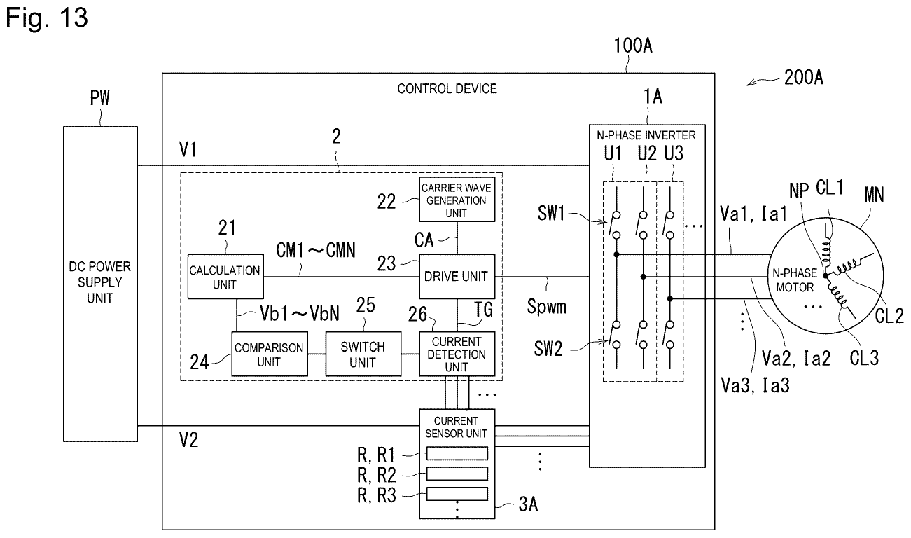

A motor module 200A according to a second embodiment of the present disclosure will be described with reference to FIGS. 13 to 17. The second embodiment is mainly different from the first embodiment in which the motor module 200 controls the three-phase inverter 1 in that the motor module 200A according to the second embodiment controls an N-phase inverter 1A. Hereinafter, a difference of the second embodiment from the first embodiment will be mainly described.

FIG. 13 is a block diagram illustrating the motor module 200A according to the second embodiment. As illustrated in FIG. 13, the motor module 200A includes a control device 100A and an N-phase motor MN. In the present specification, “N” represents an odd number of three or more. The control device 100A controls the N-phase inverter 1A that applies voltages Va1 to VaN to N phases when N is an odd number of three or more. In the example of FIG. 13, the control device 100A includes the N-phase inverter 1A. Then, the N-phase inverter 1A is connected to the DC power supply unit PW. In the present description, as an example, the N-phase inverter 1A applies the voltages Va1 to VaN having different phases to each phase of the N-phase motor MN to drive the N-phase motor MN. Hereinafter, the voltages Va1 to VaN may be referred to as the applied voltages Va1 to VaN. Currents Ia1 to IaN corresponding to the voltages Va1 to VaN flow through phases of the N-phase motor MN.

The N-phase motor MN includes coils CL1 to CLN of N phases. The N-phase motor MN is, for example, a brushless DC motor. The N-phase motor MN has P1 to PN phases. With respect to polarity of the currents Ia1 to IaN, polarity of current flowing from the N-phase inverter 1A to the neutral point NP of the N-phase motor MN is set to positive, and polarity of current flowing from the neutral point NP to the N-phase inverter 1A is set to negative. Note that a driving target of the N-phase inverter 1A is not limited to the N-phase motor MN, and may be another electric device. Further, the N-phase motor MN may be arranged outside the control device 100A.

The control device 100A further includes the calculation unit 21 and the current detection unit 26. When a phase to which (N+1)/2-th largest voltage is applied at a current detection time among the voltages Va1 to VaN applied to N phases is defined as an intermediate phase, the current detection unit 26 detects current of each of (N−1) phases other than the intermediate phase among the currents Ia1 to IaN of the N phases.

Specifically, when a phase to which (N+1)/2-th largest voltage is applied at a current detection time among the voltages Va1 to VaN applied to the coils CL1 to CLN of N phases is defined as an intermediate phase, the current detection unit 26 detects current of each of (N−1) phases other than the intermediate phase among the currents Ia1 to IaN of the N phases. As described above, in the second embodiment, the current detection unit 26 detects not current of an intermediate phase in which fluctuation and disturbance of current are relatively large but current of other (N−1) phases in which fluctuation and disturbance of current are smaller than those of the intermediate phase among the currents Ia1 to IaN. Therefore, an error in a detection result is reduced for current directly detected among the currents Ia1 to IaN.

The calculation unit 21 calculates the current value Imid of current of an intermediate phase based on a detection result of the current detection unit 26. Specifically, the calculation unit 21 calculates the current value Imid of current of an intermediate phase from the total value Isum of current values of currents of (N−1) phases other than the intermediate phase based on Kirchhoff's laws. Imid=−Isum. As described above, in the second embodiment, the calculation unit 21 calculates current of an intermediate phase from a detection result of currents of other (N−1) phases in which an error of a detection result is reduced as compared with the intermediate phase among the currents Ia1 to IaN. That is, current of an intermediate phase is indirectly detected. Therefore, as compared with a case where current of an intermediate phase is directly detected, it is possible to reduce an error in a detection result of current of the intermediate phase. As a result, variation in a detection value of the currents Ia1 to IaN flowing through phases including an intermediate phase and other (N−1) phases can be reduced.

Subsequently, the control device 100A will be described with reference to FIG. 13. The N-phase inverter 1A includes N switching units U1 to UN.

The N switching units U1 to UN apply the voltages Va1 to VaN to N phases. Specifically, the N switching units U1 to UN apply the voltages Va1 to VaN in different phases to the coils CL1 to CLN of N phases, respectively.

Each of the switching units U1 to UN includes the first switching element SW1 on the first voltage V1 side of the DC power supply unit PW and the second switching element SW2 on the second voltage V2 side of the DC power supply unit PW. The second switching element SW2 is connected in series with the first switching element SW1. In an example of FIG. 1, the second voltage V2 is smaller than the first voltage V1. For example, the second voltage V2 is ground voltage (0 V).

Typically, the N-phase inverter 1A is driven by the PWM signal Spwm. The PWM signal Spwm includes N first gate signals Gi1 to G1N that drive the first switching elements SW1 of the switching units U1 to UN, respectively, and N second gate signals G21 to G2N that drive the second switching elements SW2 of the switching units U1 to UN, respectively. In this case, for example, each of the first switching element SW1 and the second switching element SW2 is a semiconductor switching element. For example, each of the first switching element SW1 and the second switching element SW2 is an insulated gate bipolar transistor (IGBT). Each of the first switching element SW1 and the second switching element SW2 may be another transistor such as a field effect transistor.

Polarity of the second gate signals G21 to G2N is basically opposite to polarity of the first gate signals Gi1 to G1N, respectively. That is, the second gate signals G21 to G2N and the first gate signals Gi1 to G1N basically have a complementary relationship. However, the point that dead time may be provided is similar to the case of three phases described with reference to FIG. 3.

The control device 100A further includes a current sensor unit 3A for detecting the currents Ia1 to IaN of N phases. The current sensor unit 3A includes N electric resistance units R1 to RN for detecting the currents Ia1 to IaN of N phases. Each of the electric resistance units R1 to RN or a generic term of these may be referred to as the electric resistance unit R. The electric resistance units R1 to RN are a resistance component (for example, a resistance element) for detecting current flowing through the coils CL1 to CLN of N phases via the N-phase inverter 1A. At each current detection time, (N−1) of the electric resistance units R are used among N of the electric resistance units R1 to RN.

The electric resistance units R1 to RN are arranged corresponding to the switching units U1 to UN, respectively. Then, each of the electric resistance units R1 to RN is arranged between the second switching element SW2 of a corresponding switching unit among the switching units U1 to UN and the DC power supply unit PW.

The control device 100A further includes the carrier wave generation unit 22, the drive unit 23, the comparison unit 24, and the switch unit 25. Specifically, the control device 100A includes the inverter control unit 2. Then, the inverter control unit 2 includes the calculation unit 21, the carrier wave generation unit 22, the drive unit 23, the comparison unit 24, the switch unit 25, and the current detection unit 26. The inverter control unit 2 is, for example, a microcomputer. For example, the current detection unit 26 is realized by an A/D converter.

The calculation unit 21 calculates voltage command values Vb1 to VbN. When N of phases constituting the N phases are “P1 phase to PN phase”, the calculation unit 21 calculates the voltage command values Vb1 to VbN corresponding to the P1 phase to the PN phase, respectively. The calculation unit 21 outputs the voltage command values Vb1 to VbN to the comparison unit 24.

The voltage command values Vb1 to VbN indicate voltage values of the voltages Va1 to VaN output from the N-phase inverter 1A, respectively. Therefore, the voltage command values Vb1 to VbN substantially coincide with voltage values of the voltages Va1 to VaN output from the N-phase inverter 1A, respectively. Specifically, the voltage command values Vb1 to VbN indicate voltage values to be followed by the voltages Va1 to VaN applied to the P1 to PN phases constituting the N phases, respectively. In the present description, the voltage command values Vb1 to VbN and the applied voltages Va1 to VaN are substantially synonymous.

The calculation unit 21 calculates compare values CM1 to CMN based on the voltage command values Vb1 to VbN. Therefore, the compare values CM1 to CMN correspond to the voltage command values Vb1 to VbN, respectively. The compare values CM1 to CMN directly or indirectly indicate a duty value of the first gate signals Gi1 to G1N in the PWM signal Spwm. The calculation unit 21 outputs the compare values CM1 to CMN to the drive unit 23. Specifically, a duty value indicates a ratio of ON time of the first switching element SW1 of each phase to a preset PWM period Tpwm.

The carrier wave generation unit 22 generates the carrier wave CA. The carrier wave generation unit 22 outputs the carrier wave CA to the drive unit 23. The carrier wave CA is, for example, a triangular wave. Note that a waveform of the carrier wave CA is not particularly limited.

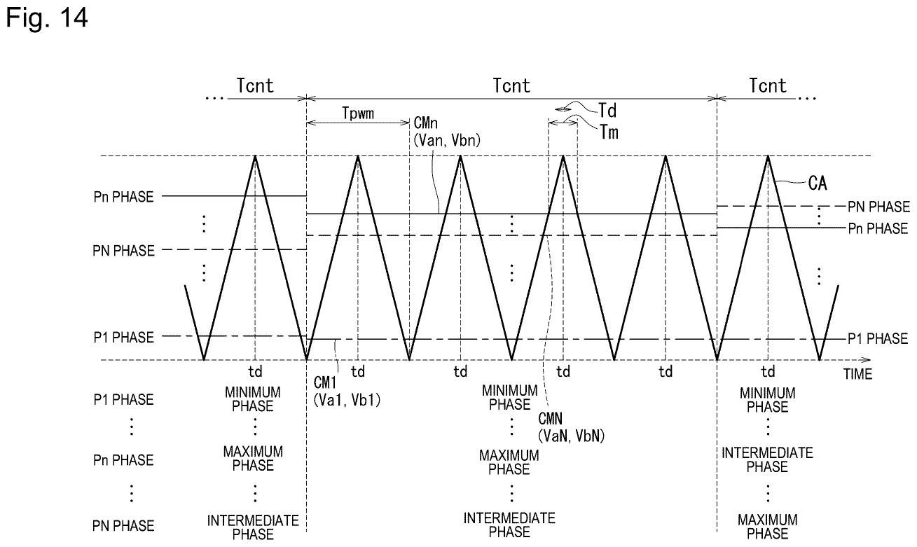

FIG. 14 is a diagram illustrating an example of the carrier wave CA and the compare values CM1 to CMN. In FIG. 14, “n” represents an integer smaller than N and larger than one. As illustrated in FIG. 14, the PWM period Tpwm is equal to a period of the carrier wave CA. Other than the above, the PWM period Tpwm of the second embodiment is similar to the PWM period Tpwm of the first embodiment.

Further, a control period Tcnt is defined by a period of the carrier wave CA. The control period Tcnt is a period for updating a duty value of the PWM signal Spwm. Therefore, a duty value of the PWM signal Spwm is updated for each of the control periods Tcnt. The control period Tcnt is longer than the PWM period Tpwm. Other than the above, the control period Tcnt of the second embodiment is similar to the control period Tcnt of the first embodiment.

Returning to FIG. 13, the drive unit 23 generates the PWM signal Spwm based on the carrier wave CA and the compare values CM1 to CMN. Then, the drive unit 23 outputs the PWM signal Spwm to the N-phase inverter 1A to drive the N-phase inverter 1A. As a result, the N-phase inverter 1A applies the voltages Va1 to VaN indicated by the voltage command values Vb1 to VbN to the coils CL1 to CLN of N phases, respectively.

Specifically, as illustrated in FIG. 14, the drive unit 23 compares each of the compare values CM1 to CMN with the carrier wave CA, and generates the PWM signal Spwm based on a comparison result. Furthermore, specifically, the drive unit 23 determines whether or not a compare value is equal to or more than a level of the carrier wave CA for each of the compare values CM1 to CMN. Then, the drive unit 23 activates or deactivates each of the first gate signals Gi1 to G1N in the PWM signal Spwm based on a determination result for each of the compare values CM1 to CMN. As a result, a duty value of N of the first gate signals Gi1 to G1N is set according to the compare values CM1 to CMN. Note that, among the first gate signals Gi1 to G1N, the first switching element SW1 to which an activated first gate signal is applied is turned on. Among the first gate signals Gi1 to G1N, the first switching element SW1 to which a deactivated first gate signal is applied is turned off.

Here, in the example of FIG. 14, for convenience of description, a magnitude relationship between the compare values CM1 to CMN and a magnitude relationship between the voltage command values Vb1 to VbN (the applied voltages Va1 to VaN) are matched. Therefore, in description of the comparison unit 24 of FIG. 13, for convenience, a straight line indicating the compare values CM1 to CMN is regarded as a straight line indicating the voltage command values Vb1 to VbN (the applied voltages Va1 to VaN) in FIG. 14.

The comparison unit 24 compares the voltage command values Vb1 to VbN of the P1 phase to the PN phase constituting N phases with each other at each of the current detection times td, and determines the order of magnitude of the voltage command values Vb1 to VbN of the P1 phase to the PN phase. In other words, the comparison unit 24 compares the voltages Va1 to VaN to be applied to the P1 to PN phases with each other at each of the current detection times td, and determines the order of magnitude of the voltages Va1 to VaN applied to the P1 phase to the PN phase. Furthermore, in other words, the comparison unit 24 determines an intermediate phase and a maximum phase from among the P1 phase to the PN phase. Note that the comparison unit 24 may determine a minimum phase. For example, in the control period Tcnt in the center of FIG. 14, the PN phase is an intermediate phase, the Pn phase is a maximum phase, and the P1 phase is a minimum phase.

The intermediate phase is a phase to which the (N+1)/2-th largest voltage command value is set at the current detection time td among the voltage command values Vb1 to VbN for the P1 to PN phases constituting N phases. That is, the intermediate phase is a phase to which (N+1)/2-th largest voltage is applied at the current detection time td among the voltages Va1 to VaN applied to the P1 to PN phases, respectively.

The maximum phase is a phase to which the largest voltage command value is set at the current detection time td among the voltage command values Vb1 to VbN for the P1 to PN phases constituting N phases. That is, the maximum phase is a phase to which largest voltage is applied at the current detection time td among the voltages Va1 to VaN applied to the P1 to PN phases, respectively.

Note that the minimum phase is a phase to which the smallest voltage command value is set at a current detection time among the voltage command values Vb1 to VbN for the P1 to PN phases constituting N phases. That is, the minimum phase is a phase to which smallest voltage is applied at the current detection time td among the voltages Va1 to VaN applied to the P1 to PN phases, respectively.

Here, in FIG. 14, as an example, attention is paid on the control period Tcnt in the center in FIG. 14. In this case, a Pn phase is the maximum phase. The switch unit 25 in FIG. 13 determines whether or not the period Tm during which the second switching element SW2 of a switching unit Un for applying voltage Van to the Pn phase as a maximum phase is turned on is shorter than the period Td set in advance for detection of current by the current detection unit 26. In a case of determining that the period Tm is not shorter than the period Td, that is, in a case of determining that the period Tm is equal to or more than the period Td, the switch unit 25 determines to detect current of each of (N−1) phases other than an intermediate phase.

Note that, in the example of FIG. 14, in a case where a compare value CMn is less than a level of the carrier wave CA, the drive unit 23 activates a second gate signal G2n and turns on the second switching element SW2 of the switching unit Un.

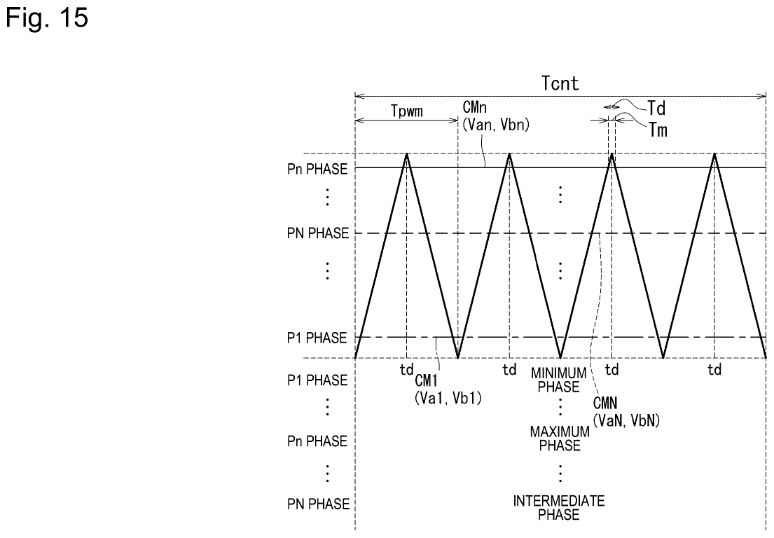

FIG. 15 is a diagram illustrating another example of the carrier wave CA and the compare values CM1 to CMN. As illustrated in FIG. 15, for example, the Pn phase is a maximum phase. The switch unit 25 in FIG. 13 determines whether or not the period Tm during which the second switching element SW2 as a maximum phase is turned on is shorter than the period Td set in advance for detection of current by the current detection unit 26. In a case of determining that the period Tm is shorter than the period Td, the switch unit 25 determines to detect current of each of (N−1) phases other than a maximum phase. That is, in this case, current of an intermediate phase is detected instead of a maximum phase.

Returning to FIG. 13, the current detection unit 26 detects current via the current sensor unit 3 in response to the trigger TG generated by the drive unit 23. A time when the trigger TG is generated is a current detection time.

Specifically, in a case where the switch unit 25 determines to detect current of each of (N−1) phases other than an intermediate phase, the current detection unit 26 detects current of each of the (N−1) phases other than the intermediate phase in response to the trigger TG generated by the drive unit 23. Then, the current detection unit 26 outputs a signal indicating a current value of current of each of the (N−1) phases other than the intermediate phase to the calculation unit 21. The calculation unit 21 calculates a current value of current of the intermediate phase based on a current value of current of each of the (N−1) phases other than the intermediate phase.

On the other hand, in a case where the switch unit 25 determines to detect current of each of the (N−1) phases other than a maximum phase, the current detection unit 26 detects current of each of the (N−1) phases other than the maximum phase in response to the trigger TG generated by the drive unit 23. Then, the current detection unit 26 outputs a signal indicating a current value of current of each of the (N−1) phases other than the maximum phase to the calculation unit 21. The calculation unit 21 calculates a current value of current of the maximum phase based on a current value of current of each of the (N−1) phases other than the maximum phase. Specifically, the calculation unit 21 calculates the current value Imax of current in the maximum phase from the total value Isum of current values of the (N−1) phases other than the maximum phase based on Kirchhoff's laws. Imax=−Isum.

As described above with reference to FIGS. 13 and 15, in a case where detection of current of a maximum phase by the current detection unit 26 is not possible because a duty value of a first gate signal applied to the first switching element SW1 of the maximum phase is near 100% or is 100%, the current is substituted with current of an intermediate phase, so that a current value of the currents Ia1 to IaN of N phases can be detected.

Note that, within a PWM period Twpm, the period Tm during which the second switching element SW2 of a maximum phase is turned on is shorter than the period Td, which means that a period during which the first switching element SW1 of the maximum phase is turned on within the PWM period Twpm is long. In this case, a duty value of the first gate signal Gln of the maximum phase is near 100%.

Further, within the PWM period Twpm, the period Tm during which the second switching element SW2 of a maximum phase is turned on is zero, which means that the first switching element SW1 of the maximum phase is turned on in an entire period of the PWM period Twpm. In this case, a duty value of a first gate signal applied to the first switching element SW1 of the maximum phase is 100%.

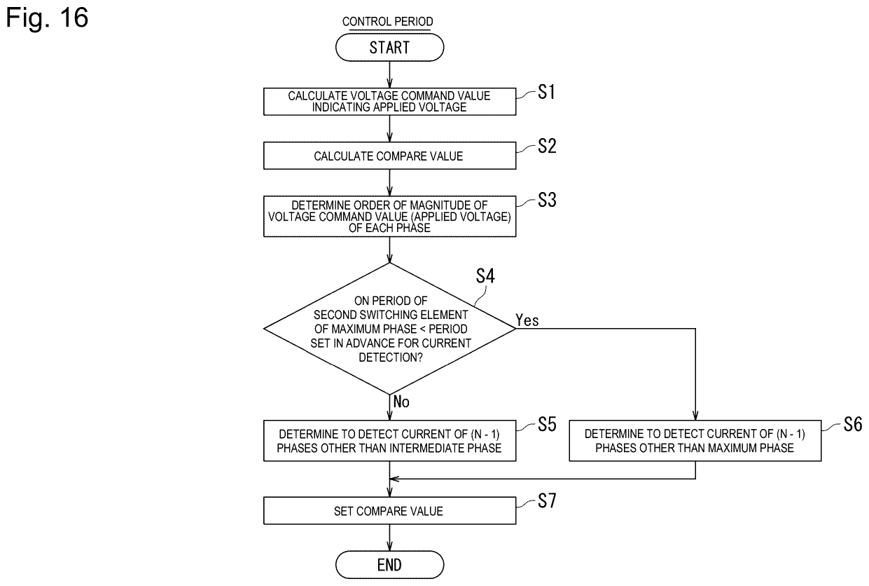

Next, phase determination processing will be described with reference to FIGS. 13 and 16. FIG. 4 is a flowchart illustrating phase determination processing for determining a phase for directly detecting current. As illustrated in FIG. 16, the phase determination processing includes Steps S1 to S7. The phase determination processing is repeatedly executed in each of the control periods Tcnt.

As illustrated in FIGS. 13 and 16, in Step S1, the calculation unit 21 calculates the voltage command values Vb1 to VbN indicating the applied voltages Va1 to VaN, respectively.

Next, in Step S2, the calculation unit 21 calculates the compare values CM1 to CMN based on the voltage command values Vb1 to VbN.

Next, in Step S3, the comparison unit 24 compares the voltage command values Vb1 to VbN of the P1 to PN phases, and determines the order of magnitude of the voltage command values Vb1 to VbN of the P1 to PN phases. Then, the comparison unit 24 determines a phase to which the largest voltage command value among the voltage command values Vb1 to VbN is set as a maximum phase. Further, the comparison unit 24 determines, as an intermediate phase, a phase to which the (N+1)/2-th largest voltage command value among the voltage command values Vb1 to VbN is set.

In other words, the comparison unit 24 compares the voltages Va1 to VaN applied to the P1 phase to the PN phase, and determines the order of magnitude of the voltages Va1 to VaN. Then, the comparison unit 24 determines a phase to which largest voltage among the voltages Va1 to VaN applied to the P1 to PN phases is applied as a maximum phase. Further, the comparison unit 24 determines, as an intermediate phase, a phase to which (N+1)/2-th highest voltage is applied among the voltages Va1 to VaN applied to the P1 to PN phases.

Next, in Step S4, the switch unit 25 determines whether or not the on period Tm of the second switching element SW2 corresponding to the maximum phase is shorter than the period Td preset for current detection to the current detection unit 26.

In a case where the on-period Tm is determined not to be shorter than the period Td in Step S4 (No), the processing proceeds to Step S5. That is, in a case where the on-period Tm is determined to be equal to or more than the period Td in Step S4, the processing proceeds to Step S5.

Next, in Step S5, the switch unit 25 determines to detect current of (N−1) phases other than the intermediate phase. For example, the switch unit 25 sets a flag indicating that current of (N−1) phases other than the intermediate phase is detected.

On the other hand, in a case where the on-period Tm is determined to be smaller than the period Td in Step S4 (Yes), the processing proceeds to Step S6.

Next, in Step S6, the switch unit 25 determines to detect current of (N−1) phases other than the maximum phase. For example, the switch unit 25 sets a flag indicating that current of (N−1) phases other than the maximum phase is detected.

Next, in Step S7 after Step S5 and Step S6, the calculation unit 21 sets the compare values CM1 to CMN calculated in Step S2 to the drive unit 23. Then, the processing ends.

Here, the compare values CM1 to CMN set to the drive unit 23 in Step S7 executed in the certain control period Tcnt are reflected by the drive unit 23 at the next control period Tcnt or a timing determined by a microcomputer used as the inverter control unit 2. Further, determination in Steps S5 and S6 executed in the certain control period Tcnt is reflected by the switch unit 25 and the current detection unit 26 at the next control period Tcnt or a timing determined by a microcomputer used as the inverter control unit 2.

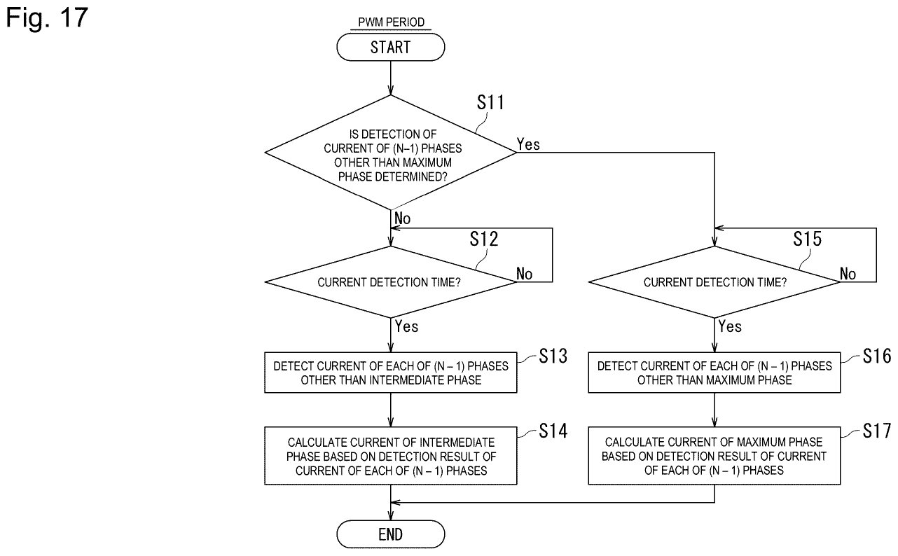

Next, current value calculation processing will be described with reference to FIGS. 13 and 17. FIG. 17 is a flowchart illustrating the current value calculation processing for calculating a current value of undetected current. As illustrated in FIG. 17, the current value calculation processing includes Steps S11 to S17. The current value calculation processing is repeatedly executed for each of the PWM periods Tpwm. Steps S11 to S17 correspond to an example of “control method executed by a control device”.

As illustrated in FIGS. 13 and 17, in Step S11, the switch unit 25 determines whether or not current of (N−1) phases other than the maximum phase is determined to be detected. That is, the switch unit 25 determines whether or not a flag indicating that current of (N−1) phases other than the maximum phase is detected is set.

In a case where it is determined in Step S11 that current of (N−1) phases other than the maximum phase is not determined to be detected (No), the processing proceeds to Step S12. That is, in a case where it is determined in Step S11 that current of (N−1) phases other than the intermediate phase is determined to be detected, the processing proceeds to Step S12.

Next, in Step S12, the current detection unit 26 determines whether or not a current detection time has come. That is, the current detection unit 26 determines whether or not the drive unit 23 outputs the trigger TG.

In a case where it is determined in Step S12 that a current detection time has not come (No), the processing repeats Step S12.

On the other hand, in a case where it is determined in Step S12 that a current detection time has come (Yes), the processing proceeds to Step S13.

Next, in Step S13, the current detection unit 26 detects current of (N−1) phases other than the intermediate phase. Step S13 corresponds to an example of “current detection step”.

Next, in Step S14, the calculation unit 21 calculates a current value of current of the intermediate phase based on a detection result of current of each of (N−1) phases other than the intermediate phase. Step S14 corresponds to an example of “calculation step”. Then, the processing ends.

On the other hand, in a case where it is determined in Step S11 that current of (N−1) phases other than the maximum phase is determined to be detected (Yes), the processing proceeds to Step S15.

Next, in Step S15, the current detection unit 26 determines whether or not a current detection time has come. That is, the current detection unit 26 determines whether or not the drive unit 23 outputs the trigger TG.

In a case where it is determined in Step S15 that a current detection time has not come (No), the processing repeats Step S15.

On the other hand, in a case where it is determined in Step S15 that a current detection time has come (Yes), the processing proceeds to Step S16.

Next, in Step S16, the current detection unit 26 detects current of (N−1) phases other than the maximum phase.

Next, in Step S17, the calculation unit 21 calculates a current value of current of the maximum phase based on a detection result of current of each of (N−1) phases other than the maximum phase. Then, the processing ends.

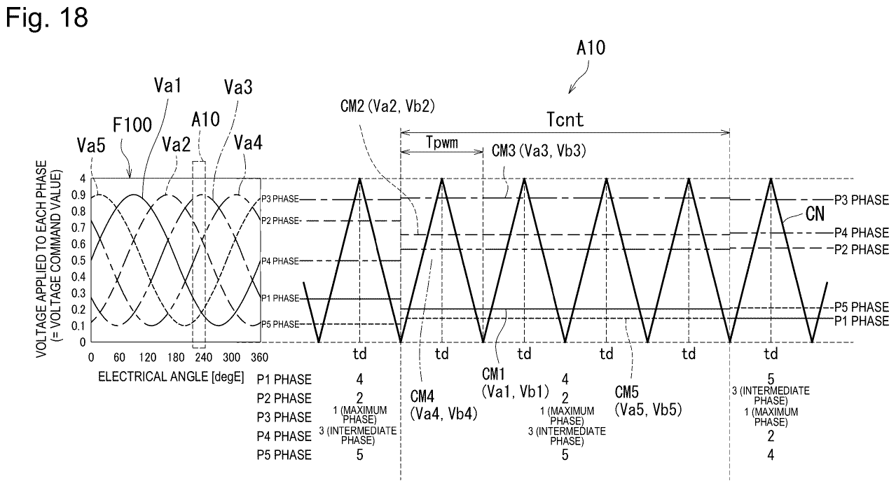

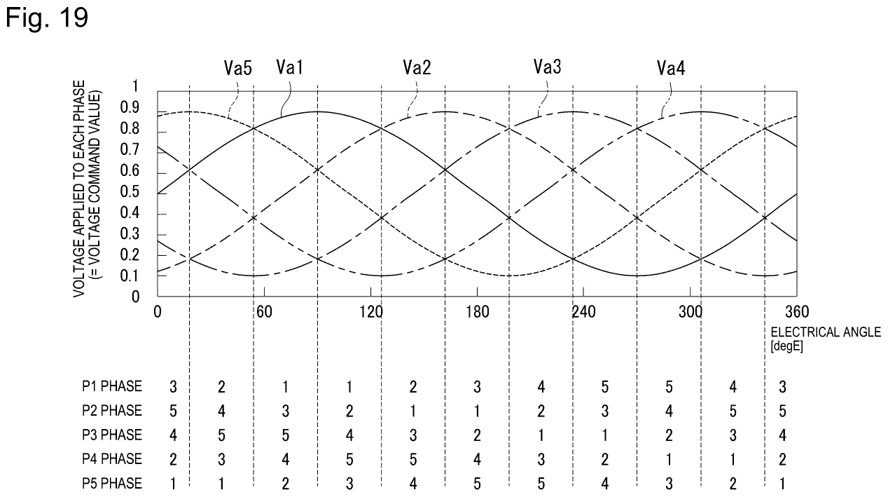

Next, an example in which N is “5” and N phases are five phases will be described with reference to FIGS. 18 and 19. FIG. 18 is a diagram illustrating an example of the voltages Va1, Va2, Va3, Va4, and Va5 applied to five phases, the carrier wave CA, and the compare values CM1, CM2, CM3, CM4, and CM5 in the second embodiment.

A waveform diagram F100 of FIG. 18 illustrates the voltages Va1, Va2, Va3, Va4, and Va5 applied to the P1 phase, the P2 phase, the P3 phase, the P4 phase, and the P5 phase, respectively. In the waveform diagram F100, the horizontal axis represents an electrical angle [degE], and the vertical axis represents the voltages Va1 to Va5. The vertical axis of the waveform diagram F100 represents a voltage value normalized by the input voltages V1 to V2, and the voltages Va1 to Va5 take a value in a range of zero to one. Further, this value also represents a duty value, which is a ratio of ON time of the first switching element SW1 of each phase to the PWM period Tpwm. As illustrated in the waveform diagram F100, the voltages Va1 to Va5 are sinusoidal. Phases of the voltages Va1 to Va5 are different from each other. In the example of FIG. 18, energization by five-phase modulation is executed.

In FIG. 18, the carrier wave CA and the compare values CM1 to CM5 in an electrical angle range (time range) illustrated in a region A10 of the waveform diagram F100 are illustrated in a right region of the waveform diagram F100. The compare values CM1 to CM5 and the voltage command values Vb1 to Vb5 (applied voltages Va1 to Va5) are updated for each of the control periods Tcnt.

The drive unit 23 compares each of the compare values CM1 to CM5 with the carrier wave CA in each of the PWM periods Tpwm. As a result, the first gate signals Gi1 to G15 and the second gate signals G21 to G25 are generated. In the second embodiment, the drive unit 23 generates the first gate signals G11 to G15 and the second gate signals G21 to G25 by a center alignment system.

Here, also in FIG. 18, similarly to the case of FIG. 4, in description of the comparison unit 24, a straight line indicating the compare values CM1 to CM5 is regarded as a straight line indicating the voltage command values Vb1 to Vb5 (the applied voltages Va1 to Va5) for convenience.

The comparison unit 24 compares the voltage command values Vb1 to Vb5 of five phases with each other at each of the current detection times td, and determines the order of magnitude of the voltage command values Vb1 to Vb5. Focusing on the control period Tcnt in the center of FIG. 18, the comparison unit 24 determines that the voltage command value Vb3 is the first largest, the voltage command value Vb2 is the second largest, the voltage command value Vb4 is the third largest, the voltage command value Vb1 is the fourth largest, and the voltage command value Vb5 is the fifth largest.

Therefore, the comparison unit 24 determines a phase to which the voltage command value Vb3 is set as a maximum phase, and determines a phase to which the voltage command value Vb4 is set as an intermediate phase. As a result, the current detection unit 26 detects current of four phases other than the P4 phase which is an intermediate phase. Specifically, the current detection unit 26 detects the current Ia1 of the P1 phase, the current Ia2 of the P2 phase, the current Ia3 of the P3 phase (maximum phase), and the current Ia5 of the P5 phase via the electric resistance units R1, R2, R3, and R5.

Then, the calculation unit 21 calculates a current value of the current Ia4 of an intermediate phase based on a current value of the current Ia1, the current Ia2, the current Ia3, and the current Ia5.

FIG. 19 is a diagram illustrating a change in order of magnitude of the P1 phase to the P5 phase in an electrical angle range of 0 [degE] to 360 [degE] in five-phase modulation. The horizontal axis and the vertical axis in FIG. 19 are similar to the horizontal axis and the vertical axis in the waveform diagram F100 illustrated in FIG. 18. In FIG. 19, the order of magnitude is shown from No. 1 to No. 5 for the P1 to P5 phases. As illustrated in FIG. 19, the order of magnitude of the P1 to P5 phases changes for each predetermined electrical angle [degE].

As described above with reference to FIGS. 18 and 19, as an example, in a case where energization of five-phase modulation is executed, current of four phases other than an intermediate phase is detected and current of an intermediate phase is calculated, so that it is possible to reduce variation in a detection value of the currents Ia1 to Ia5 of five phases.

### Third Embodiment

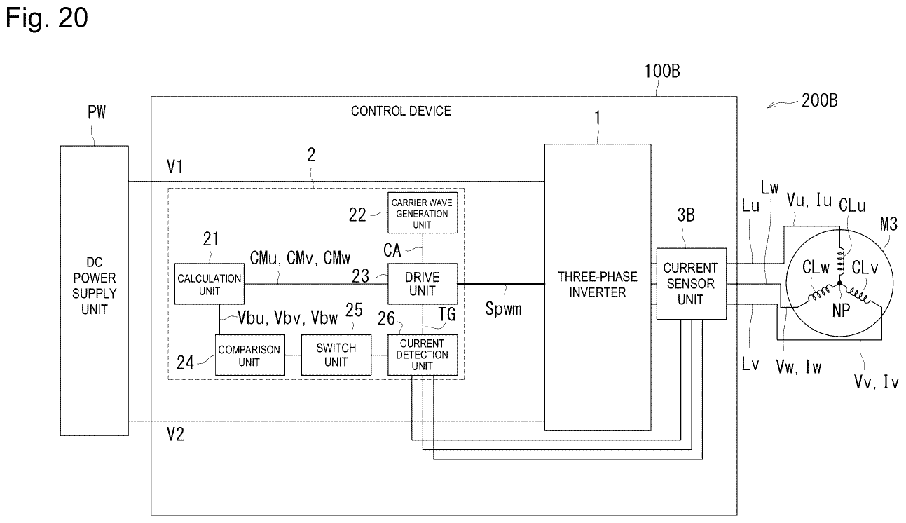

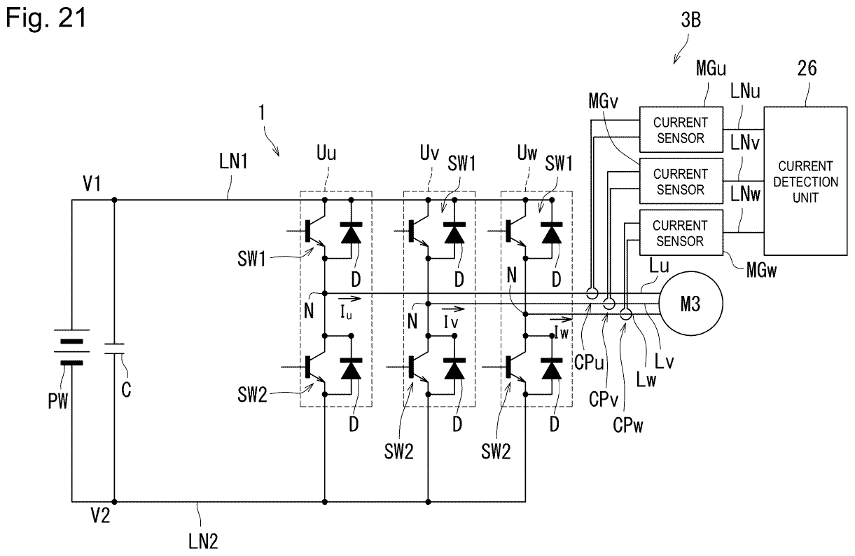

A motor module 200B according to a third embodiment of the present disclosure will be described with reference to FIGS. 20 and 21. The third embodiment is mainly different from the first embodiment in which the current sensor unit 3 of an electric resistance type is provided in that a current sensor unit 3B of a clamp type is provided. Hereinafter, a different point between the third embodiment and the first embodiment will be mainly described.

FIG. 20 is a diagram illustrating the motor module 200B according to the third embodiment. As illustrated in FIG. 20, the motor module 200B includes a control device 100B. The control device 100B includes the current sensor unit 3B for detecting the currents Iu, Iv, and Iw of three phases. The current sensor unit 3B is, for example, a clamp type. The current sensor unit 3B is arranged between the three-phase inverter 1 and the three-phase motor M3.

FIG. 21 is a diagram illustrating the current sensor unit 3B according to the third embodiment. As illustrated in FIG. 21, the current sensor unit 3B includes a magnetic core CPu for detecting the current Iu of a U phase, a magnetic core CPv for detecting the current Iv a V phase, a magnetic core CPw for detecting current of a W phase, a current sensor MGu, a current sensor MGv, and a current sensor MGw. For example, the magnetic cores CPu, CPv, and CPw surround lines Lu, Lv, and Lw, respectively.

The magnetic core CPu is arranged on the line Lu. The line Lu is an electric wire that connects the connection point N in the switching unit Uu and the coil CLu of a U phase. The magnetic core CPu detects a magnetic flux corresponding to a current value of the current Iu flowing through the line Lu. For example, a magnetic flux is proportional to a current value. The magnetic core CPu is connected to the current sensor MGu. The current sensor MGu converts a magnetic flux detected by the magnetic core CPu into the voltage signal SGu and outputs the voltage signal SGu to the current detection unit 26. The voltage signal SGu represents a current value of the current Iu flowing through the line Lu. The current sensor MGu is connected to the amplification unit 33u in FIG. 8 by the signal line LNu. Therefore, similarly to the first embodiment, the voltage signal SGu is input to the amplification unit 33u. The current sensor MGu includes, for example, a magnetic sensor such as a Hall element. In order to ensure magnetic flux detection accuracy, the current sensor MGu is arranged, for example, near the magnetic core CPu or in the magnetic core CPu.

The magnetic core CPv is arranged on the line Lv. The line Lv is an electric wire that connects the connection point N in the switching unit Uv and the coil CLv of a V phase. The magnetic core CPv detects a magnetic flux corresponding to a current value of the current Iv flowing through the line Lv. For example, a magnetic flux is proportional to a current value. The current sensor MGv converts a magnetic flux detected by the magnetic core CPv into the voltage signal SGv and outputs the voltage signal SGv to the current detection unit 26. The voltage signal SGv represents a current value of the current Iv flowing through the line Lv. The current sensor MGv is connected to the amplification unit 33v in FIG. 8 by the signal line LNv. Therefore, similarly to the first embodiment, the voltage signal SGv is input to the amplification unit 33u. The current sensor MGv includes, for example, a magnetic sensor such as a Hall element. In order to ensure magnetic flux detection accuracy, the current sensor MGv is arranged, for example, near the magnetic core CPv or in the magnetic core CPv.

The magnetic core CPw is arranged on the line Lw. The line Lw is an electric wire that connects the connection point N in the switching unit Uw and the coil CLw of a W phase. The magnetic core CPw detects a magnetic flux corresponding to a current value of the current Iw flowing through the line Lw. For example, a magnetic flux is proportional to a current value. The current sensor MGw converts a magnetic flux detected by the magnetic core CPw into the voltage signal SGw and outputs the voltage signal SGw to the current detection unit 26. The voltage signal SGw represents a current value of the current Iw flowing through the line Lw. The current sensor MGw is connected to the amplification unit 33w in FIG. 8 by the signal line LNw. Therefore, similarly to the first embodiment, the voltage signal SGw is input to the amplification unit 33w. The current sensor MGw includes, for example, a magnetic sensor such as a Hall element. In order to ensure magnetic flux detection accuracy, the current sensor MGw is arranged, for example, near the magnetic core CPw or in the magnetic core CPw.

As described above with reference to FIGS. 20 and 21, according to the third embodiment, the lines Lu, Lv, and Lw are connected to the connection points N in the switching units Uu, Uv, and Uw, respectively. Then, current of a maximum phase and a minimum phase among the currents Iu, Iv, and Iw flows into the current sensor unit 3B from the lines Lu, Lv, and Lw. Therefore, the current detection unit 26 can detect current of a maximum phase and a minimum phase through the current sensor unit 3B regardless of whether the second switching element SW2 is turned on or off. That is, the current detection unit 26 can detect current of a maximum phase and a minimum phase without being restricted by the second switching element SW2.

### Fourth Embodiment

The motor module 200B according to a fourth embodiment of the present disclosure will be described with reference to FIGS. 20, 22, and 23. An overall configuration of the motor module 200B according to the fourth embodiment is similar to an overall configuration of the motor module 200B according to the third embodiment illustrated in FIG. 20. The fourth embodiment is mainly different from the third embodiment in which the current sensor unit 3B includes the magnetic cores CPu, CPv, and CPw in that the current sensor unit 3B of the fourth embodiment includes the electric resistance units Ru, Rv, and Rw. Hereinafter, a different point between the fourth embodiment and the third embodiment will be mainly described.

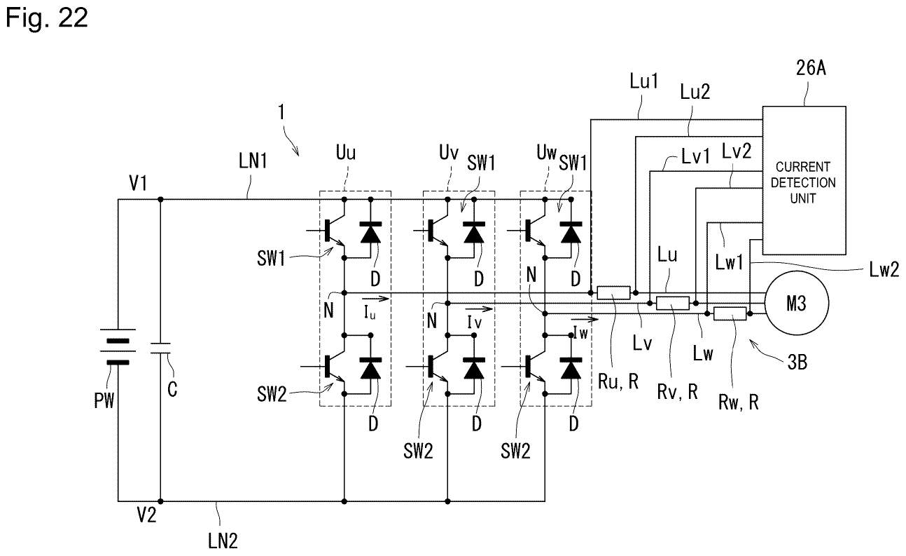

FIG. 22 is a diagram illustrating the current sensor unit 3B according to the fourth embodiment. As illustrated in FIG. 22, the current sensor unit 3B includes the electric resistance units Ru, Rv, and Rw for detecting the currents Iu, Iv, and Iw of three phases, respectively. A configuration of the electric resistance units Ru, Rv, and Rw is, for example, similar to a configuration of the electric resistance units Ru, Rv, and Rw in FIG. 3. Further, in the fourth embodiment, a current detection unit 26A to be described later is provided instead of the current detection unit 26 illustrated in FIGS. 20 and 21.

The electric resistance unit Ru is arranged on the line Lu through which the current Iu of a U phase flows. The line Lu extends from the connection point N in the switching unit Uu to the coil CLu (FIG. 20). That is, the electric resistance unit Ru is connected between the connection point N and the coil CLu. The electric resistance unit Rv is arranged on the line Lv through which the current Iv of a V phase flows. The line Lv extends from the connection point N of the switching unit Uv to the coil CLv (FIG. 20). That is, the electric resistance unit Rv is connected between the connection point N and the coil CLv. The electric resistance unit Rw is arranged on the line Lw through which the current Iw of a W phase flows. The line Lw extends from the connection point N of the switching unit Uw to the coil CLw (FIG. 20). That is, the electric resistance unit Rw is connected between the connection point N and the coil CLw.

Signal lines Lu1 and Lu2 extend from both ends of the electric resistance unit Ru to the current detection unit 26A. Therefore, the current detection unit 26A can detect a potential difference between both ends of the electric resistance unit Ru. The potential difference between both ends of the electric resistance unit Ru has magnitude corresponding to the current Iu flowing through the electric resistance unit Ru. A current value of the current Iu can be calculated by dividing a potential difference between both ends of the electric resistance unit Ru by a resistance value of the electric resistance unit Ru. Signal lines Lv1 and Lv2 extend from both ends of the electric resistance unit Rv to the current detection unit 26A. Therefore, the current detection unit 26A can detect a potential difference between both ends of the electric resistance unit Rv. The potential difference between both ends of the electric resistance unit Rv has magnitude corresponding to the current Iv flowing through the electric resistance unit Rv. A current value of the current Iv can be calculated by dividing a potential difference between both ends of the electric resistance unit Rv by a resistance value of the electric resistance unit Rv. Signal lines Lw1 and Lw2 extend from both ends of the electric resistance unit Rw to the current detection unit 26A. Therefore, the current detection unit 26A can detect a potential difference between both ends of the electric resistance unit Rw. The potential difference between both ends of the electric resistance unit Rw has magnitude corresponding to the current Iw flowing through the electric resistance unit Rw. A current value of the current Iw can be calculated by dividing a potential difference between both ends of the electric resistance unit Rw by a resistance value of the electric resistance unit Rw.

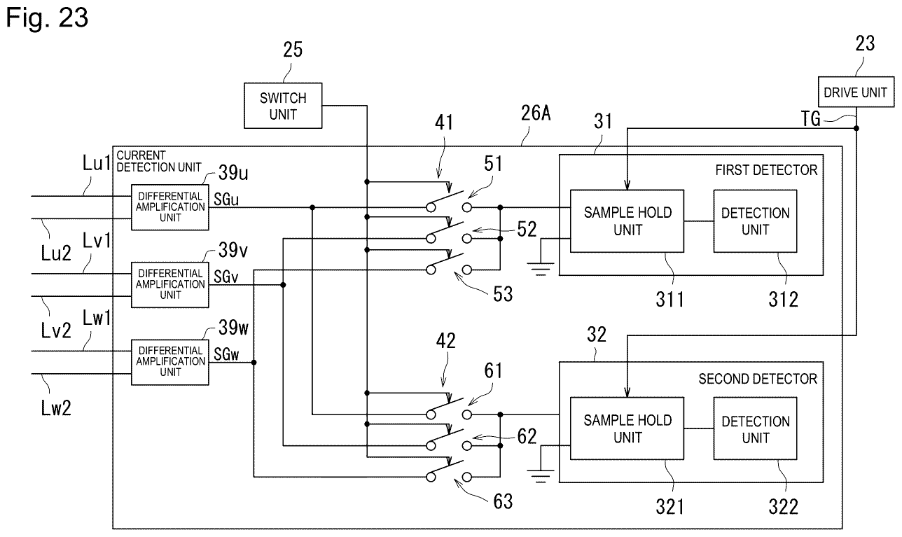

FIG. 23 is a diagram illustrating the current detection unit 26A according to the fourth embodiment. As illustrated in FIG. 23, the current detection unit 26A includes differential amplification units 39u, 39v, and 39w instead of the amplification units 33u, 33v, and 33w illustrated in FIG. 8. Each of the differential amplification units 39u, 39v, and 39w is, for example, a differential amplification unit including an operational amplifier or the like.

The signal lines Lu1 and Lu2 are connected to the differential amplification unit 39u. Therefore, the differential amplification unit 39u amplifies a potential difference between both ends of the electric resistance unit Ru (FIG. 22), and outputs the voltage signal SGu indicating the amplified potential difference to the first selection unit 41 and the second selection unit 42. Processing of the voltage signal SGu in and after the differential amplification unit 39u is similar to the processing of the voltage signal SGu in and after the amplification unit 33u illustrated in FIG. 8. Note that, for example, after the voltage signal SGu is converted into a digital signal by the detection unit 312 or the detection unit 322, the calculation unit 21 calculates a current value of the current Iu by dividing a potential difference between both ends of the electric resistance unit Ru indicated by a digital signal by a resistance value of the electric resistance unit Ru.

The signal lines Lv1 and Lv2 are connected to the differential amplification unit 39v. Therefore, the differential amplification unit 39v amplifies a potential difference between both ends of the electric resistance unit Rv (FIG. 22), and outputs the voltage signal SGv indicating the amplified potential difference to the first selection unit 41 and the second selection unit 42. Processing of the voltage signal SGv in and after the differential amplification unit 39v is similar to the processing of the voltage signal SGv in and after the amplification unit 33v illustrated in FIG. 8. Note that, after the voltage signal SGv is converted into a digital signal by the detection unit 312 or the detection unit 322, the calculation unit 21 calculates a current value of the current Iv by dividing a potential difference between both ends of the electric resistance unit Rv indicated by a digital signal by a resistance value of the electric resistance unit Rv.

The signal lines Lw1 and Lw2 are connected to the differential amplification unit 39w. Therefore, the differential amplification unit 39w amplifies a potential difference between both ends of the electric resistance unit Rw (FIG. 22), and outputs the voltage signal SGw indicating the amplified potential difference to the first selection unit 41 and the second selection unit 42. Processing of the voltage signal SGw in and after the differential amplification unit 39w is similar to the processing of the voltage signal SGw in and after the amplification unit 33w illustrated in FIG. 8. Note that, after the voltage signal SGw is converted into a digital signal by the detection unit 312 or the detection unit 322, the calculation unit 21 calculates a current value of the current Iw by dividing a potential difference between both ends of the electric resistance unit Rw indicated by a digital signal by a resistance value of the electric resistance unit Rw.

As described above with reference to FIG. 22, according to the fourth embodiment, the lines Lu, Lv, and Lw are connected to the connection points N in the switching units Uu, Uv, and Uw, respectively. Then, current of a maximum phase and a minimum phase among the currents Iu, Iv, and Iw flows into the current sensor unit 3B from the lines Lu, Lv, and Lw. Therefore, the current detection unit 26A can detect current of a maximum phase and a minimum phase through the current sensor unit 3B regardless of whether the second switching element SW2 is turned on or off. That is, the current detection unit 26A can detect current of a maximum phase and a minimum phase without being restricted by the second switching element SW2. Further, since the electric resistance units Ru, Rv, and Rw are used, the control device 100B can be realized relatively inexpensively.

The embodiments of the present invention are described above with reference to the drawings. However, the present invention is not limited to the above embodiments, and can be implemented in various aspects in a range not departing from the gist of the present invention. Further, a plurality of constituent elements disclosed in the above embodiments can be appropriately modified. For example, one constituent element of all constituent elements illustrated in one embodiment may be added to a constituent element of another embodiment, or some constituent elements of all components illustrated in one embodiment may be eliminated from the embodiment.

Further, the drawings schematically illustrate each constituent element mainly in order to facilitate understanding of the invention, and the thickness, length, number, interval, and the like of the illustrated constituent elements may be different from the actual ones for convenience of creation of the drawings. Further, a configuration of each constituent element illustrated in the above embodiment is an example and is not particularly limited, and it goes without saying that various modifications can be made without substantially departing from the effect of the present invention.

In FIGS. 20 to 22, the control device 100B controls the three-phase inverter 1. However, the control device 100B may control the N-phase inverter 1A. In this case, for example, in FIG. 21, the current sensor unit 3B includes N magnetic cores and N current sensors. For example, in FIG. 22, the current sensor unit 3B includes N of the electric resistance units R.

### INDUSTRIAL APPLICABILITY

The present invention can be suitably used for a control device and a control method.

### REFERENCE SIGNS LIST

1 three-phase inverter
1A N-phase inverter
26, 26A current detection unit
31 first detector
32 second detector
Uu, Uv, Uw, U1 to UN switching unit
SW1 first switching element
SW2 second switching element
Ru, Rv, Rw, R, R1 to RN electric resistance unit

1. A control device that controls an N-phase inverter that applies voltage to each of N phases when N is an odd number of three or more, the control device comprising:
a current detection unit that detects current of each of (N−1) phases other than an intermediate phase among currents of the N phases when a phase to which (N+1)/2-th largest voltage is applied at a current detection time among voltages applied to the N phases is defined as the intermediate phase; and
a calculation unit that calculates a current value of current of the intermediate phase based on a detection result of the current detection unit.

2. The control device according to claim 1, wherein the N is “3”, and the N phases are three phases.

3. The control device according to claim 2, wherein
the current detection unit includes a first detector and a second detector,
the first detector detects current of a maximum phase among currents of the three phases when a phase to which largest voltage among voltages applied to the three phases is applied at the current detection time is set as the maximum phase, and
the second detector detects current of a minimum phase among currents of the three phases when a phase to which smallest voltage among voltages applied to the three phases is applied at the current detection time is set as the minimum phase.

4. The control device according to claim 3, wherein
the N-phase inverter is a three-phase inverter driven by a PWM signal,
the three-phase inverter includes three switching units that apply voltage to the three phases, and
each of the three switching units includes
a first switching element on a first voltage side of a DC power supply unit, and
a second switching element on a second voltage side of the DC power supply unit, the second switching element being connected in series with the first switching element,
the control device further comprising three electric resistance units for detecting current of each of the three phases,
wherein
each of the three electric resistance units is connected between the second switching element and the DC power supply unit, and
the current detection unit detects current of each phase flowing through two of the three electric resistance units connected to two of the second switching elements that are turned on at the current detection time synchronized with a carrier wave for generating the PWM signal.

5. The control device according to claim 4, wherein in a case where a period (Tm in FIG. 7) in which the second switching element for applying voltage to the maximum phase is turned on is determined to be shorter than a period (Td in FIG. 7) set in advance for detection of current by the current detection unit, the current detection unit detects current of the intermediate phase instead of the maximum phase, and the calculation unit calculates a current value of current of the maximum phase based on a detection result of current of the intermediate phase and current of the minimum phase.

6. A control method executed by a control device that controls an N-phase inverter that applies voltage to each of N phases when N is an odd number of three or more, the control method comprising:
a current detection step of detecting current of each of (N−1) phases other than an intermediate phase among currents of the N phases when a phase to which (N+1)/2-th largest voltage is applied at a current detection time among voltages applied to the N phases is defined as the intermediate phase; and
a calculation step of calculating a current value of current of the intermediate phase based on a detection result of the current detection step.
